(19) United States
(12) Patent Application Publication
(10) Pub. No.: US 2023/0417546 A1
(43) Pub. Date: Dec. 28, 2023

(54) DEVICES, SYSTEMS AND METHOD FOR ANALYSIS AND CHARACTERIZATION OF SURFACE TOPOGRAPHY

(71) Applicants: University of Pittsburgh - Of the Commonwealth System of Higher Education, Pittsburgh, PA (US); Albert-Ludwigs-Universität Freiburg Freiburg (DE), Freiburg (DE)

(72) Inventors: Tevis Davis Jacobs, Pittsburgh, PA (US); Lars Pastewka, Freiburg (DE); Paul Martin Strauch, Eschborn (DE); Antoine Nicolas Sanner, Zürich (CH); Michael Clemens Röttger, Freiburg (DE)

(21) Appl. No.: 18/340,845

(22) Filed: Jun. 24, 2023

Related U.S. Application Data
(60) Provisional application No. 63/355,281, filed on Jun. 24, 2022.

(51) Int. Cl. G01B 21/30

(52) U.S. Cl. CPC G01B 21/30

(57) ABSTRACT

A method of characterizing a surface topography includes determining scale-dependent parameters. Each of the scale-dependent parameters represents a statistical characterization of a distribution of at least one of a first-order or higher-order derivative of surface height or h determined from one or more measurements of the surface at each of multiple distance scales. For at least one of the one or more measurements, the first-order or higher-order derivative of surface height is determined at the multiple distance scales in real space defined via a scaling factor η which is greater than or equal to 1 and which is multiplied by the smallest possible distance scale or resolution provided by the at least one of the one or more measurements.

### CROSS-REFERENCE TO RELATED APPLICATIONS

This application claims benefit of U.S. Provisional Patent Application Ser. No. 63/355,281, filed Jun. 24, 2022, the disclosure of which is incorporated herein by reference.

### GOVERNMENTAL INTEREST

This invention was made with government support under grant numbers 1727378 and 1844739 awarded by the National Science Foundation. The government has certain rights in the invention.

### BACKGROUND

The following information is provided to assist the reader in understanding technologies disclosed below and the environment in which such technologies may typically be used. The terms used herein are not intended to be limited to any particular narrow interpretation unless clearly stated otherwise in this document. References set forth herein may facilitate understanding of the technologies or the background thereof. The disclosure of all references cited herein are incorporated by reference.

Properties of surfaces are strongly affected by surface topography or roughness. Such properties include the friction force between two contacting bodies and adhesion (that is, how strongly two surfaces stick together). These properties are important in any industry that builds devices with moving and contacting parts, for example: automotive, aerospace, manufacturing.

Adequately characterizing surface topography and linking surface topography to functional properties is very desirable during device design (for example, in research and development) or for quality assurance/quality control (QA/QC). In general, surface topography or roughness may, for example, be quantified by deviations in the height of a surface from a smooth reference plan or, for example, from the mean plane of the surface. At present, it is common practice to measure topography at one single-size scale using, for example, a stylus profilometer. This type of single measurement is, for example, applied to manufactured parts in quality-assurance procedures.

There are a number of problems with the existing practices for measuring and characterizing surface topography/roughness. Real-world surface topography cannot be adequately described by individual measurements, which capture only a limited range of size-scales of the topography. Real, manufactured surfaces exhibit topography variation or roughness across many size scales. Moreover, functional properties depend on topography across many or all scales. Current approaches to measure and analyze topography are inadequate to describe and/or predict properties.

### SUMMARY

In one aspect, a method of characterizing a surface topography includes determining scale-dependent parameters. Each of the scale-dependent parameters represents a statistical characterization of a distribution of at least one of a first-order or higher-order derivative of surface height or h determined from one or more measurements of the surface at each of multiple distance scales. For at least one of the one or more measurements, the first-order or higher-order derivative of surface height is determined at the multiple distance scales in real space defined via a scaling factor η which is greater than or equal to 1 and which is multiplied by the smallest possible distance scale or resolution provided by the at least one of the one or more measurements. At least one characteristic of the subject surface may be determined from the scale-dependent parameters.

The method may further include statistically characterizing the distribution of each of a plurality of derivatives of surface height of different order at the multiple distance scales in characterizing the surface topography. At least one of the one or more derivatives of surface height may, for example, be a third- or higher-order derivative.

The distribution of the at least one of the first-order or higher-order derivatives may be determined over the multiple distance scales via a numerical method and then statistically characterized to determine a scale dependent parameter hereof. The numerical method may, for example, be a finite difference method, a finite-elements method, a Fourier interpolation or another interpolation method using compact or spectral basis sets. A scale dependent parameter may alternatively be determined, in the case that the statistical characterization is determined for a second cumulant or second moment, from a surface topography parameter which is not determined from the distribution of the first-order or higher-order derivatives of surface height determined via a numerical method. In the case of such a surface topography parameter, the scale-dependent parameter is determined by application of a determined mathematical relationship to the surface topography parameter to convert the surface topography parameter to the scale-dependent parameter. The surface topography parameter may, for example, be selected from the group of an autocorrelation function characterization, a variable bandwidth method characterization, or a power spectral density characterization.

The at least one of the first-order or higher-order derivatives may be determined over multiple distance scales for lines of the one or more measurements of the surface or for areas of the one or more measurements of the surface. The distribution of the at least one of the first-order or higher-order derivatives may, for example, be determined over the multiple distance scales for lines of the one or more measurements of the surface and averaged over multiple lines of the one or more measurements of the surface. In a number of embodiments, the derivatives for lines of the one or more measurements for points xₖ on the lines is provided by the formula:

$$\frac{{D}_{( η )}^{α}}{{D}_{( η )} {x}^{α}} h ( x ) ≡ \frac{1}{{( η Δ x )}^{α}} \text{?} h ( \text{?} ) .$$

$$\text{?} \text{indicates text missing or illegible when filed}$$

wherein α is the order, Δx is the smallest possible scale, and cₗ^{(a)} set forth a stencil of the derivative, and wherein the derivative is measured at a distance scale [symbol] =αηΔx. The stencils for the α=1, 2 and 3 may, for example, be

c₀⁽¹⁾=−1,c₁⁽¹⁾=1,

c₀⁽²⁾=−2,cₖ₁⁽²⁾=1 and

c₀⁽³⁾=3,c₁⁽³⁾=−3,c₋₁⁽³⁾=−1,c₂⁽³⁾=1,

wherein all other cₗ^{(a)} are zero.

The first-order or higher-order derivatives may be determined for areas of the one or more measurements of the surface, and the first-order or higher-order derivatives may be provided by the formula:

$$\frac{{D}_{( η )}^{α + β}}{{D}_{( η )} {x}^{α} {D}_{( η )} {y}^{β}} h ( x , y ) ≡ \frac{1}{{( η Δ x )}^{α} {( η Δ y )}^{β}} {\sum }_{l = - ∞}^{∞} {\sum }_{m = - ∞}^{∞} {c}_{lm}^{( α , β )} h ( x + η l Δ x , y + η m Δ y )$$

wherein α and β are orders of derivatives in the x and y directions, respectively, and cₗₘ^{(α,β)} set forth a stencil.

The statistical characterization of the distribution may, for example, be determined from a second or higher cumulant thereof or a second or higher moment thereof. In a number of embodiments, the statistical characterization of the distribution is selected from the group consisting of variance, skewness, and kurtosis. In a number of embodiments, the statistical characterization of the distribution is determined from a third or higher cumulant thereof or from a third or higher moment thereof.

The distribution may, for example, be provided by the formula:

$${P}_{α} ( χ \text{?} η ) = 〈 δ ( χ - \frac{\text{?}}{\text{?}} h ( x ) ) 〉 ,$$

$$\text{?} \text{indicates text missing or illegible when filed}$$

wherein δ is the Dirac δ function, and χ is the value of the derivative of order α. The δ function may be broadened into individual bins and the number of occurrences of a certain derivative value is counted.

In a number of embodiments, a tip-radius effect for a measurement methodology used for the one or more measurements is determined as a function of a minimum value of a second-order derivative at a specific scale [symbol] . A critical scale [symbol] ₜᵢₚ may, for example, be determined and data on scales below [symbol] ₜᵢₚ are excluded to minimize tip radius effects. In a number of embodiments, [symbol] ₜᵢₚ is estimated numerically using the formula:

h″ₘᵢₙ( [symbol] ₜᵢₚ)=c/Rₜᵢₚ,

wherein h″ₘᵢₙ( [symbol] ₜᵢₚ) is a minimum value of the second-order derivative at the scale ( [symbol] ₜᵢₚ) and Rₜᵢₚ is a tip radius provided by the formula:

$$\text{?} ( ℓ ) \text{?} [ \frac{\text{?}}{\text{?}} ] ,$$

$$\text{?} \text{indicates text missing or illegible when filed}$$

and c is an empirically determined parameter.

In a number of embodiments, more than one measurement is used in determining the scale-dependent parameters. In a number of embodiments, such measurements are determined or conducted via different measurement methodologies and/or have different smallest possible distance scales or resolutions. In a number of embodiments, the different measurement methodologies are selected from the group consisting of stylus profilometry methodologies, optical profilometry methodologies, cross-section or side-view microscopy methodologies and reflectance methodologies. Data from the more than measurement may be combined over the multiple distance scales in determining the scale-dependent parameters.

In a number of embodiments, the method further includes determining a feature vector from the one or more measurements of the surface, wherein a plurality of features of the feature vector are determined from scale dependent parameters, and based upon the feature vector, determining at least one characteristic of the subject surface.

In another aspect, a system for characterizing a surface topography includes a processor system and a memory system in communicative connection with the processor system. The memory system includes an algorithm to determine scale-dependent parameters, each of which represents a statistical characterization of a distribution of at least one of a first-order or higher-order derivative of surface height or h determined from one or more measurements of the surface at each of multiple distance scales. For at least one of the one or more measurements, the first-order or higher-order derivative of surface height is determined at the multiple distance scales in real space using a scaling factor η which is greater than or equal to 1 and which is multiplied by the smallest possible distance scale or resolution provided by the at least one of the one or more measurements.

In a number of embodiments, the algorithm statistically characterizes the distribution of each of a plurality of derivatives of surface height of different order at the multiple distance scales. The statistical characterization of the distribution may, for example, be determined from a third or higher cumulant thereof or is a third or higher moment thereof.

In a number of embodiments, the system further includes a measurement system for measuring surface height over an area of a surface in communicative connection with the processor system.

In another aspect, a non-transitory, computer readable medium for characterizing a surface topography includes instruction stored thereon, that when executed on a processor, determine scale-dependent parameters, each of scale dependent parameter representing a statistical characterization of a distribution of at least one of a first-order or higher-order derivative of surface height or h determined from one or more measurements of the surface at each of multiple distance scales, wherein for at least one of the one or more measurements, the first-order or higher-order derivative of surface height is determined at the multiple distance scales in real space defined via a scaling factor η which is greater than or equal to 1 and which is multiplied by the smallest possible distance scale or resolution provided by the at least one of the one or more measurement.

In another aspect, a method of characterizing a surface topology of a subject surface includes determining a feature vector from one or more measurements of the subject surface, a plurality of features of the feature vector representing or being determined from a statistical characterization of a distribution of one or more derivatives of surface height or h, wherein the one or more derivatives are selected from the group consisting of a zero- and higher-order derivative determined from at least one of the one or more measurements of the subject surface at each of multiple distance scales, wherein for the at least one of the one or more measurements, the one or more derivatives of surface height are determined at the multiple distance scales in real space using a scaling factor η which is greater than or equal to 1 and which is multiplied by the smallest possible distance scale provided by the at least one of the one or more measurements, determining via an algorithm stored in a memory system and executable via a processor system, and based upon the feature vector, at least one characteristic of the subject surface; and providing an output indicating the at least one characteristic.

At least one of the one or more derivatives of surface height h may, for example, be a third- or higher-order derivative. At least one of the one or more derivatives of surface height h may, for example, be a fourth-order or higher-derivative.

The plurality of features of the feature vector may be determined from the statistical characterization of distributions of more than one derivative of surface height, the more than one derivative having different orders. The one or more derivatives of surface height may be selected from the group consisting of a zero-order derivative, a first-order derivative, a second-order derivative, a third-order derivative and a derivative of higher order than a third-order derivative. In a number of embodiments, the one or more derivatives of surface height are selected from the group consisting of a first- or higher-order derivatives. In a number of embodiments, the one or more derivatives of surface height include third or higher-order derivatives. In a number of embodiments, values of the plurality of features are standardized.

In a number of embodiments, the statistical characterization of the distribution is determined from a second or higher cumulant thereof or a second or higher moment thereof. In a number of embodiments, the statistical characterization of the distribution is a third or higher cumulant thereof or a third or higher moment thereof. The statistical characterization of the distribution may, for example, be selected from the group consisting of variance, skewness, and kurtosis.

The first-order or higher-order derivatives may be determined over multiple distance scales for lines of the one or more measurements of the surface or for areas of the one or more measurements of the surface. The distribution of the at least one of the first-order or higher-order derivatives may, for example, be determined over the multiple distance scales for lines of the one or more measurements of the surface and averaged over multiple lines of the one or more measurements of the surface. In a number of embodiments, the derivatives for lines of the one or more measurements for points xₖ on the lines is provided by the formula:

$$\frac{{D}_{( η )}^{α}}{{D}_{( η )} {x}^{α}} h ( x ) ≡ \frac{1}{{( η Δ x )}^{α}} \text{?} h ( \text{?} ) \text{?}$$

$$\text{?} \text{indicates text missing or illegible when filed}$$

wherein α is the order, Δx is the smallest possible scale, and cₗ^{(a)} set forth a stencil of the derivative, and wherein the derivative is measured at a distance scale [symbol] =αηΔx. The stencils for the α=1, 2 and 3 may, for example, be

c₀⁽¹⁾=−1,c₁⁽¹⁾=1,

c₀⁽²⁾=−2,cₖ₁⁽²⁾=1 and

c₀⁽³⁾=3,c₁⁽³⁾=−3,c₋₁⁽³⁾=−1,c₂⁽³⁾=1,

wherein all other cₗ^{(a)} are zero.

The first-order or higher-order derivatives may be determined for areas of the one or more measurements of the surface, and the first-order or higher-order derivatives may be provided by the formula:

$$\frac{{D}_{( η )}^{α + β}}{{D}_{( η )} {x}^{α} {D}_{( η )} {y}^{β}} h ( x , y ) ≡ \frac{1}{{( η Δ x )}^{α} {( η Δ y )}^{β}} {\sum }_{l = - ∞}^{∞} {\sum }_{m = - ∞}^{∞} {c}_{lm}^{( α , β )} h ( x + η l Δ x , y + η m Δ y )$$

wherein α and β are orders of derivatives in the x and y directions, respectively, and cₗₘ^{(α,β)} set forth a stencil.

The distribution may, for example, be provided by the formula:

$${P}_{α} ( χ \text{?} η ) = 〈 δ ( χ - \frac{\text{?}}{\text{?}} h ( x ) ) 〉 ,$$

$$\text{?} \text{indicates text missing or illegible when filed}$$

wherein δ is the Dirac δ function, and χ is the value of the derivative of order α. The δ function may be broadened into individual bins and the number of occurrences of a certain derivative value is counted.

In a number of embodiments, a tip-radius effect for a measurement methodology used for the one or more measurements is determined as a function of a minimum value of a second-order derivative at a specific scale [symbol] . A critical scale [symbol] ₜᵢₚ may, for example, be determined and data on scales below [symbol] ₜᵢₚ are excluded to minimize tip radius effects. In a number of embodiments, [symbol] ₜᵢₚ is estimated numerically using the formula:

h″ₘᵢₙ( [symbol] ₜᵢₚ)=c/Rₜᵢₚ,

wherein h″ₘᵢₙ( [symbol] ₜᵢₚ) is a minimum value of the second-order derivative at the scale ( [symbol] ₜᵢₚ) and Rₜᵢₚ is a tip radius provided by the formula:

$$\text{?} ( ℓ ) \text{?} [ \frac{\text{?}}{\text{?}} ] ,$$

$$\text{?} \text{indicates text missing or illegible when filed}$$

and c is an empirically determined parameter.

In a number of embodiments, more than one measurement is used in defining the statistical characterizations, wherein each of the more than one measurement is created via a different measurement methodology and/or has a different smallest possible distance scale or resolution. The different measurement methodologies may, for example, be selected from the group consisting of stylus profilometry methodologies, scanning-probe microscopy, optical profilometry methodologies, cross-section or side-view microscopy methodologies and reflectance methodologies. Data from the one or more measurement created via more than one measurement methodology may be combined over the multiple distance scales in determining the statistical characterizations.

In a number of embodiments, the algorithm includes at least one machine learning model. The at least one machine learning model may, for example, be a classification model or a regression model. The classification model may, for example, include a support vector machine model, a Gaussian process classifier model or a neural network. In a number of embodiments, the at least one machine learning model is trained using features and labels of a training set of one or more measurements of each of a plurality of training surfaces.

The method may further include reducing the dimensionality of the feature vector before input into the at least one machine learning model. A principal component analysis algorithm or an autoencoder may, for example, be used for reducing the dimensionality. In a number of embodiments, a principal component analysis algorithm or an autoencoder algorithm hereof is adapted to handle missing values of data or data sets having different bandwidth.

In a further aspect, a system for characterizing a surface topology of a subject surface includes a memory system, a processor system in operative connection with the memory system, and a database system stored in the memory system. The system further includes an algorithm stored in the memory system and executable via the processor system. The algorithm determines a feature vector from one or more measurements of the subject surface. A plurality of features of the feature vector representing or are determined from a statistical characterization of a distribution of one or more derivatives of surface height or h. The one or more derivatives are selected from the group consisting of a zero- and higher-order derivative determined from at least one of one or more measurements of the subject surface at each of multiple distance scales. For the at least one of the one or more measurements, the one or more derivatives of surface height are determined at the multiple distance scales in real space using a scaling factor η which is greater than or equal to 1 and which is multiplied by the smallest possible distance scale provided by the at least one of the one or more measurements. The algorithm further determines at least one characteristic of the subject surface based upon the feature vector and provides an output indicating the at least one characteristic.

In a further aspect, a non-transitory, computer readable medium for characterizing a surface topography includes instructions stored thereon, that when executed on a processor, determine a feature vector from one or more measurements of the subject surface, a plurality of features of the feature vector representing or being determined from a statistical characterization of a distribution of one or more derivatives of surface height or h, wherein the one or more derivatives are selected from the group consisting of a zero- and higher-order derivative determined from at least one of the one or more measurements of the subject surface at each of multiple distance scales, wherein for the at least one of the one or more measurements, the one or more derivatives of surface height are determined at the multiple distance scales in real space using a scaling factor η which is greater than or equal to 1 and which is multiplied by the smallest possible distance scale provided by the at least one of the one or more measurements, and determine, based upon the feature vector, at least one characteristic of the subject surface. The instruction, when executed on a processor, may further provide an output indicating the at least one characteristic.

In still a further aspect, a system includes a memory system, a processor system in operative connection with the memory system, and a database system stored in the memory system. The database system includes topography data associated with one or more measurements of each of a plurality of surfaces. The topography data includes a statistical characterization of a distribution of one or more derivatives of surface height or h for at least one of the one or more measurements, wherein the one or more derivatives are selected from the group consisting of a zero- and higher-order derivatives determined at each of multiple distance scales in real space using a scaling factor η which is greater than or equal to 1 and which is multiplied by the smallest possible distance scale provided by the at least one of the one or more measurements. The system further includes an algorithm stored in the memory system and executable via the processor system. The algorithm includes at least one machine learning model trained using a training set of the topography data using features and labels of a training set of the topography data.

The present devices, systems, and methods, along with the attributes and attendant advantages thereof, will best be appreciated and understood in view of the following detailed description taken in conjunction with the accompanying drawings.

### BRIEF DESCRIPTION OF THE DRAWINGS

FIG. 1 illustrates basic concepts behind the scale-dependent parameters, wherein panel (a) illustrates an example line scan showing the computation of slopes h′(l) and curvatures h′( [symbol] ) from finite differences at different distances [symbol] , shown for [symbol] =40Δx and [symbol] =80Δx, where Δx is the sample spacing, panel (b) illustrates local slope, obtained at a distance scale of [symbol] =40Δx for the line scan shown in panel (a), and panel (c) illustrates the distribution of the local slope obtained from the slope profile shown in panel (b).

FIG. 2 illustrates formulas for root mean squared height hᵣₘₛ (variance), skewness sk and kurtosis ku.

FIG. 3 illustrates the computation of scale-dependent roughness parameters from the variable bandwidth method (VBM).

FIG. 4 illustrates derivative coefficients for finite differences [symbol] and the Fourier-filtered derivative [symbol] for different distance scales [symbol] , wherein the coefficients agree at small wavevectors q, and the maximum of the coefficient agrees if the filter wavelength λₑ=2 [symbol] , corresponding to the Nyquist sampling theorem.

FIG. 5A illustrates a map of height variation for an ideal self-affine surface with Hurst exponent H=0.8 wherein a large surface was subsampled in three topographies of 500×500 pixels at different resolution.

FIG. 5B illustrates individual power spectral densities or PSDs displayed as a function of wavelength λ=2π/q, where q is the wavevector of the surface of FIG. 5A.

FIG. 5C illustrates the square root of the autocorrelation function (ACF) displayed as a function of distance scale C.

FIG. 5D illustrates the scale-dependent rms slope of the surface of FIG. 5A.

FIG. 5E illustrates the scale-dependent rms curvature of the surface of FIG. 5A.

FIG. 5F illustrates the third derivative of the surface of FIG. 5A as an example of how the method hereof can be used to go beyond traditional analysis.

FIG. 6A illustrates a map of height variation in a computer-generated “pristine” topography which was scanned with a virtual tip of Rₜᵢ=40 nm radius, wherein the bottom row shows cross-sectional profiles of the maps above.

FIG. 6B illustrates the distribution of slopes at distance scales [symbol] =1 nm, 16 nm and 256 nm of the surface of FIG. 6A.

FIG. 6C illustrates the distribution of curvatures at these scales of FIG. 6B, wherein the slopes and curvatures are obtained in the x-direction, and the left plots in FIGS. 6B and 6C show the computed values for the pristine surface, while the right plots show the values for the tip-artifacted measurement, and wherein the solid lines show the normal distribution.

FIG. 6D illustrates PSDs for the surface topographies of FIG. 6A.

FIG. 6E illustrates ACFs of the surface topographies of FIG. 6A.

FIG. 6F illustrates a plot of minimum curvature h″ₘᵢₙ which shows a clear deviation between the pristine and the artifacted measurement that starts at approximately the point where the scale-dependent minimum curvature equals the radius of the tip.

FIG. 7A illustrates atomic force microscopy (AFM) measurement of a map of height variation of an ultrananocrystalline diamond film showing the smoothing of peaks similar to emulated scans.

FIG. 7B illustrates normalized curvature distribution at distance scales [symbol] =2 nm, 47 nm and 187 nm, wherein [symbol] =12 nm corresponds to a scale factor η=1 for the surface topography of FIG. 7A.

FIG. 7C illustrates use of the peak curvature h″ₘᵢₙ to estimate the scale lₜᵢₚ below which the AFM data is unreliable with an empirical constant c=½, and the inset illustrates a transmission electron microscopy (TEM) image of the AFM tip, wherein fitting a parabola to the tip yields a radius Rₜᵢₚ of 10 nm for the surface topography of FIG. 7A.

FIG. 7D illustrates PSD of the measurement wherein scaling with λ⁴ indicates tip artifacts.

FIG. 8A illustrates topography measurements of an ultrananocrystalline diamond film which are combined across eight orders of magnitude of scales using the PSD.

FIG. 8B illustrates topography measurements of the ultrananocrystalline diamond film of FIG. 8A which are combined across eight orders of magnitude of scales using the ACF.

FIG. 8C illustrates topography measurements of an ultrananocrystalline diamond film of FIG. 8A which are combined across eight orders of magnitude of scales using the rms slope.

FIG. 8D illustrates topography measurements of an ultrananocrystalline diamond (UNCD) film of FIG. 8A which are combined across eight orders of magnitude of scales using the (rms curvature, wherein for each of FIGS. 8A through 8D, a curve representative of the surface was obtained by averaging over all the individual measurements (solid line).

FIG. 9 illustrates a 5-fold cross validation, wherein shaded bunches are the training set and white bunches are the validation set.

FIG. 10 illustrates scale-dependent parameter curves of an ultrananocrystalline diamond surface wherein panel (a) illustrates slope, panel (b) illustrates curvature, and panel (c) illustrates 3^{rd} derivative for skewness and kurtosis functions.

FIG. 11, panels (a) and (b) illustrates height maps of synthetic surfaces with different Hurst exponents of H=0.3 and 0.8, respectively.

FIG. 12 illustrates principal component analysis (PCA) and scree plots for standardized (panel (a)) and non-standardized features (panel (b)) of height, slope, curvature, and 3^{rd} derivative, as well as standardized (panel (c)) and non-standardized features (panel (d)) of slope, curvature, and 3^{rd} derivative, and standardized (panel (e)) and non-standardized features (panel (f)) of curvature, and 3^{rd} derivative.

FIG. 13 illustrates visual classification areas trained by the standardized features of height, slope, curvature, and 3^{rd} derivative in the two dimensional PCA subspace for classification with the support vector machine (SVM), wherein the drawn dots are the training set (H=0.8).

FIG. 14 illustrates visual classification areas trained by the standardized features of height, slope, curvature, and 3^{rd} derivative in the two dimensional PCA subspace for classification with the Gaussian process classifier (GPC) classification with the rbf-kernel, wherein shading indicates probability of class (H=0.8).

FIG. 15 illustrates feature relevance estimated by the 1^{st} principal component for standardized features (panel (a) and non-standardized features panel (b)), and feature relevance estimated by Recursive Feature Elimination (RFE) for standardized features (all with features of height, slope, curvature, and 3^{rd} derivative).

FIG. 16 illustrates scatter plots of two features each with panel (a) setting forth the best rated features of RFE, panel (b) setting forth the best rated features of the first principal component for non-standardized data, and panel (c) setting forth the best rated features of skewness and kurtosis by RFE.

FIG. 17 illustrates a setup of line scans used to extract 100 feature vectors from a 2500×2500 nm measurement of a UNCD surface, each with a pixel size of 512×512.

FIG. 18 illustrates “zoomed-in” PCA plots, wherein panel (a) sets forth standardized features of height, slope, curvature, and 3^{rd} derivative, panel (b) sets forth non-standardized features of height, slope, curvature, and 3^{rd} derivative, panel (c) sets forth standardized features of curvature, and 3^{rd} derivative, and panel (d) sets forth non-standardized features of curvature, and 3^{rd} derivative.

FIG. 19 illustrates feature relevance estimated by the 1^{st} principal component for standardized features in panel (a), feature relevance estimated by RFE for standardized features in panel (b), and feature relevance estimated by RFE for non-standardized features in panel (c) (all with features of height, slope, curvature, and 3^{rd} derivative).

FIG. 20 illustrates scatter plots of two features, wherein panel (a) illustrates a plot of the best rated skewness feature and the best rated kurtosis feature of RFE for non-standardized features, and panel (b) illustrates a plot of the best rated features of RFE for the standardized features.

FIG. 21 illustrates PCA plots of standardized features of height, slope, curvature, and 3^{rd} derivative in panel (a), non-standardized features of height, slope, curvature, and 3^{rd} derivative in panel (b), standardized features of curvature, and 3^{rd} derivative in panel (c), and non-standardized features of curvature, and 3^{rd} derivative in panel (d).

FIG. 22 illustrates a subset of data points belonging to the validation set for a train-validation split with the prediction probabilities for each class provided by the GPC.

FIG. 23 illustrates feature relevance estimated by the 1^{st} principal component in panel (a) and by the RFE in panel (b), wherein are set forth for standardized features of height, slope, curvature, and 3^{rd} derivative.

FIG. 24 illustrates PCA plots of (a) standardized features of height, slope, curvature, and 3^{rd} derivative in panel (a) and non-standardized features of height, slope, curvature, and 3^{rd} derivative in panel (b).

FIG. 25 illustrates feature relevance estimated by the 1^{st} principal component for standardized features of height, slope, curvature, and 3^{rd} derivative in panel (a) and by RFE for standardized features of height, slope, curvature, and 3^{rd} derivative in panel (b).

FIG. 26 illustrates an embodiment of a value removal scheme for the entire bandwidth or full data set, which is given by the solid, thick lines, wherein panel (a) sets forth removed scales for 25% missing values, and for each of the two configurations, the higher scales (solid thin line) or the lower scales (dashed line) are removed for a subset of feature vectors, and wherein panel (b) sets forth removed scales for the 40%, 60%, and 75% missing value configurations, and wherein, for 40% both dashed line and solid line scales (below the full data sheet line) are removed independently of each other to a subset of data points, and for 60% and 75%, additionally the scales represented by the dashed line above the full data set line in panel (b) are removed independently towards the other scale sections.

FIG. 27 illustrates PCA plots of both configurations of FIG. 26 with 25% missing values, wherein panel (a) illustrates large scales removed (solid-line scales in panel (a) of FIG. 26) and panel (b) illustrates small scales removed (dashed-line scales in panel (a) of FIG. 26) of some data points, wherein the data points with cross-hatching are the PCA representation without missing values.

FIG. 28 illustrates PCA plots with 40% missing values in panel (a), 60% missing values in panel (b), and 75% missing values in panel (c).

FIG. 29 illustrates schematically an embodiment of a system hereof.

### DESCRIPTION

In a number of embodiments, devices, systems, methods and compositions hereof provide analysis and characterization of surface topography or roughness.

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well-known structures, materials, or operations are not shown or described in detail to avoid obfuscation.

As used herein and in the appended claims, the singular forms “a,” “an”, and “the” include plural references unless the context clearly dictates otherwise. Thus, for example, reference to “an algorithm” includes a plurality of such algorithms and equivalents thereof known to those skilled in the art, and so forth, and reference to “the algorithm” is a reference to one or more such algorithms and equivalents thereof known to those skilled in the art, and so forth. Recitation of ranges of values herein are merely intended to serve as a shorthand method of referring individually to each separate value falling within the range. Unless otherwise indicated herein, each separate value, as well as intermediate ranges, are incorporated into the specification as if individually recited herein. All methods described herein can be performed in any suitable order unless otherwise indicated herein or otherwise clearly contraindicated by the text.

The terms “electronic circuitry”, “circuitry” or “circuit,” as used herein include, but are not limited to, hardware, firmware, software, or combinations of each to perform a function(s) or an action(s). For example, based on a desired feature or need, a circuit may include a software controlled microprocessor, discrete logic such as an application specific integrated circuit (ASIC), or other programmed logic device. A circuit may also be fully embodied as software. As used herein, “circuit” is considered synonymous with “logic.” The term “logic”, as used herein includes, but is not limited to, hardware, firmware, software, or combinations of each to perform a function(s) or an action(s), or to cause a function or action from another component. For example, based on a desired application or need, logic may include a software-controlled microprocessor, discrete logic such as an application-specific integrated circuit (ASIC), or other programmed logic device. Logic may also be fully embodied as software.

The term “processor,” as used herein includes, but is not limited to, one or more of virtually any number of processor systems. Processor systems may include one or more stand-alone processors, such as microprocessors, microcontrollers, central processing units (CPUs), and digital signal processors (DSPs), in any combination. The processor may be associated with various other circuits that support operation of the processor, such as random access memory (RAM), read-only memory (ROM), programmable read-only memory (PROM), erasable programmable read only memory (EPROM), clocks, decoders, memory controllers, or interrupt controllers, etc. These support circuits may be internal or external to the processor or its associated electronic packaging. The support circuits are in operative communication with the processor. The support circuits are not necessarily shown separate from the processor in block diagrams or other drawings.

The term “software,” as used herein includes, but is not limited to, one or more computer readable or executable instructions that cause a computer or other electronic device to perform functions, actions, or behave in a desired manner. The instructions may be embodied in various forms such as routines, algorithms, modules, or programs including separate applications or code from dynamically linked libraries. Software may also be implemented in various forms such as a stand-alone program, a function call, a servlet, an applet, instructions stored in a memory, part of an operating system or other type of executable instructions. It will be appreciated by one of ordinary skill in the art that the form of software is dependent on, for example, requirements of a desired application, the environment it runs on, or the desires of a designer/programmer or the like.

In a number of embodiments, systems, devices and methods hereof may be used to characterize a surface topography by defining scale-dependent roughness parameters or SDRPs (variance) and scale-dependent statistical parameters or SDSPs or simply scale-dependent parameters (generalizations including parameters determined from variance and higher-order moments or cumulants such as skewness, kurtosis, as well as even higher order moments or cumulants) via a statistical characterization of a distribution of at least one of a first-order or higher-order derivative of surface height (h) determined from one or more scans of the surface at each of multiple distance scales. SDSPs or scale-dependent parameters hereof are statistical characterization of slope, curvature, and 3^{rd} (or a higher) derivative and are sometimes referred to herein as statistically-characterized, scale-dependent parameters or simply as scale-dependent parameters. In that regard, for at least one of the one or more scans, the first- or higher-order derivative of surface height may be determined at the multiple distance scales using a scaling factor η which is greater than or equal to 1 and which is multiplied by the smallest possible distance scale provided by the at least one of the one or more scans. In a number of embodiments, the method includes statistically characterizing the distribution of each of a plurality of derivatives of different order at the multiple distance scales in characterizing the surface topography to determine the scale-dependent parameters hereof.

In general, physical properties of surfaces cannot be fully understood/predicted by applying physical models to single measurements. Instead, models should be applied to measurements across different size scales. Such measurements across different size or distance scales can, for example, be achieved using combinations of measurements (for example, using different measurement methodologies). The distribution of the first- or higher-order derivatives hereof may, for example, be determined over the multiple distance scales via a numerical method (for example, a finite differences or other method) and then statistically characterized. The statistical characterization, when determined from a second order cumulant or second order moment, may alternatively be determined or estimated from a surface topography/roughness parameter other than a scale-dependent parameters hereof to which such parameters are mathematically relatable. The surface roughness/topography parameter other than scale-dependent parameters hereof may, for example, be selected from the group of an autocorrelation function characterization, a variable bandwidth characterization, or a power spectral density characterization as described below. Variable bandwidth methods (VBMs) or scaled windowed variance methods include a class of methods which differ in the way that the data is detrended. Such methods have been given a variety of names including: bridge method; roughness around the mean height (MHR) (sometimes termed VBM); detrended fluctuation analysis (DFA); and roughness around the rms straight line (SLR).

The scale-dependent parameter analysis hereof provides a generalization of commonly used topography metrics. The scale-dependent parameter analysis hereof may be used to combine such topography metrics into the scale-dependent parameter analysis hereof and may serve to harmonize disparate topography descriptors. However, the present scale-dependent parameter analysis (which is based upon a real-space measurement) also provides a number of advantages over such other methods, particularly in terms of ease of calculation, intuitive interpretability, detection of artifacts, ready combination of measurements from multiple measurement methodologies over a broad range of scales, and enablement of determination of scale-dependent parameters wherein the statistical characterization of the distribution is determined from a third or higher cumulant or a third or higher moment. The devices, systems, and methods hereof allow one to readily combine multiple measurements at different length scales and/or obtained with different measurement techniques (for example, stylus profilometry, cross-section microscopy, optical profilometry) into a single statistical description of the topography of a specimen. Moreover, as discussed above and further below, the scale-dependent parameter analysis hereof facilitates and/or enables analysis of higher cumulants or moments which include information about deviations from Gaussianity.

Surface roughness has been primarily characterized in terms of scalar parameters; especially common are the root-mean-square (rms) height and slope, which are the rms deviations from the mean height and mean slope, with or without the addition of bandwidth filters. Some variant of these quantities is computed by all surface topography instruments, and they are often reported to describe surface topography in publications. These quantities are useful for describing the amplitude of spatial fluctuations in height and slope across the measured topography. However, a core issue with these roughness parameters is that all of them explicitly depend on the scale of the measurement. For example, the rms height depends on the lateral size (largest scale) of the measurement, and the rms slope depends on the resolution (smallest scale) of the measurement. While some standardized expressions for obtaining these values, such as Rq from ISO 4287 include high- and low-frequency filtering, such values are still strongly scale-dependent, wherein the relevant scale is the size of the filter rather than the size of the measurement. See International Organization for Standardization, Geometrical product specifications (GPS)—Surface texture: Profile method—Terms, definitions and surface texture parameters, ISO Standard No. 4287, 1997.

The scale dependence of these values is typically a signature of the multiscale nature of surface topography. A simple illustration is given in a classic observation by Benoit Mandelbrot on the length of coastlines in which it was illustrated that the length L_{coast} of a coastline depends on the length of the measurement tool/yardstick [symbol] used to measure it. A smaller yardstick picks up finer details and hence leads to longer coastlines. For (self-affine) fractals, the functional relationship between L_{coast} and [symbol] is a power-law whose exponent characterizes the fractal dimension of the coastline. In the case of a surface topography measurement, [symbol] corresponds to the resolution of the scientific instrument (or filter) used to measure the topography and the property corresponding to the length of a coastline is the true surface area S( [symbol] ) of the topography. It has been demonstrated that S( [symbol] ) (and also the rms slope and curvature) scales with measurement resolution [symbol] . See A. Gujrati, S. R. Khanal, L. Pastewka, T. D. B. Jacobs, Combining TEM, AFM, and profilometry for quantitative topography characterization across all scales, ACS Appl. Mater. Interf. 10 (2018) 29169; A. Gujrati, A. Sanner, S. R. Khanal, N. Moldovan, H. Zeng, L. Pastewka, T. D., B. Jacobs, Comprehensive topography characterization of polycrystalline diamond coatings, Surf. Topogr. Metrol. Prop. 9 (2021) 014003; and S. Dalvi, A. Gujrati, S. R. Khanal, L. Pastewka, A. Dhinojwala, T. D. B. Jacobs, Linking energy loss in soft adhesion to surface roughness, Proc. NatI. Acad. Sci. USA 116 (2019) 25484. This scaling of the surface area has, for example, direct relevance to adhesion between soft surfaces. Many surfaces do not behave as ideal fractals, but nearly all surfaces exhibit some form of size dependence of the roughness parameters discussed above. In that regard, processes that shape surfaces, such as fracture, plasticity or erosion, lead to multiscale, fractal-like topography over a range of length scales.

The devices, systems, and methods hereof provide a route to generalize the above-discussed (and other) geometric properties of measured topography to explicitly contain a notion of measurement scale. An individual roughness parameter is defined as a function of scale [symbol] over which it is measured, leading to curves identifying the value of the parameter as a function of [symbol] . However, [symbol] is not restricted to the resolution of the instrument or some fixed filter cutoff. In the analysis hereof, the concept of this scale [symbol] is broadened to refer to any size over which a scale-dependent parameter hereof is computed. For a given topography scan, it can, for example, range from the pixel size or resolution up to the scan size. The resulting curves can be related to common surface roughness characterization techniques including, for example, the height-difference autocorrelation function (ACF), the variable bandwidth, method (VBM) and the power spectral density (PSD). The scale-dependent parameters hereof are very useful, in part, because they are easily interpreted. In that regard, while it is difficult to attach a geometric meaning to a certain value of the PSD (where even units can be unclear), the slope and curvature both have simple geometric interpretations. Since slope and curvature are also important considerations for modern theories of contact between rough surfaces, scale-dependent parameters hereof are directly connected to functional properties of rough surfaces. In an example of the utility of the present scale-dependent parameters, it is illustrated below how such parameters can be used to estimate tip-radius artifacts in contact-based measurements, such as scanning probe microscopy and stylus profilometry.

Surface topography is commonly described by a function h(x, y), where x and y are the coordinates in the plane of the surface. This is sometimes called the Monge representation of a surface, which is an approximation as it excludes overhangs (reentrant surfaces). A real measurement does not yield a continuous function but height values

hₖₗ=h(xₖ,yₗ) (1)

on a set of discrete points xₖ and yₗ. Measurements are often taken on equidistant samples where xₖ=kΔx and yₗ=lΔy, where Δx and Δy are the distance between the sample-points in their respective directions. Furthermore k∈[0, Nx−1] and l∈[0, Ny−1] where Nx×Ny is the total number of sample points.

Topographies are often random such that hu is a random process and its properties must be described in a statistical manner. Many have discussed this random process model of surface roughness, yet the most commonly used roughness parameters have remained simple.

Concepts hereof are demonstrated using a representative one-dimensional case, that is, for line scans or profiles. In many real scenarios, even areal topographic measurements are interpreted as a series of line scans. In the case of atomic force microscopy (AFM), for example, a topographic map is stitched together from a series of adjacent line scans. Because of temporal (instrumental) drift, these line scans may not be perfectly aligned and the “scan”-direction is then the preferred direction for statistical evaluation. In the discussion hereof, it is implicitly assumed that all values are obtained by averaging over such consecutive scans, but this average is not written explicitly in the equations that follow. Extension to true two-dimensional topography maps of the ideas presented here is straightforward and briefly discussed.

The most straightforward statistical property is the root-mean-square (rms) height,

hᵣₘₛ= [symbol] hᵢ² [symbol] ^{1/2}≡ [symbol] h²(x) [symbol] (2)

where the average [symbol] . . . [symbol] is taken over all indices k. The explicit index k is omitted in the equations following. The rms height measures the amplitude of height fluctuations on the topography, where the midline is defined as h=0. In addition to the height fluctuation, we can also quantify the amplitude of slopes,

$$\text{?} = {〈 {( \frac{D}{Dx} h ( x ) )}^{2} 〉}^{1 / 2} \qquad ( 3 )$$

$$\text{?} \text{indicates text missing or illegible when filed}$$

where D/Dx is a discrete derivative in the x-direction.

A common (but not exclusive) way to compute discrete derivatives on experimental data is to use a finite-differences approximation. Finite-differences approximate the height h(x) locally as a polynomial (a Taylor series expansion). The first derivative can then be computed as

$$\frac{\partial }{\partial x} h ( x ) \approx \frac{D}{Dx} h ( x ) = \frac{h ( x + Δ x ) - h ( x )}{Δ x} . \qquad ( 4 )$$

This expression is called the first-order right-differences scheme. The symbol D is used for the discrete derivatives, and the term “order” herein refers to the truncation order, or how fast the error decays with grid spacing Δx: it drops linearly with decreasing Δx in this scheme. Another interpretation is that the truncation order gives the highest exponent of the polynomial used to interpolate between the points x and x+Δx. The derivative of a linear interpolation is constant between these points and given by Eq. (4).

As clear to one skilled in the art, right, left, or central finite differences may be used in the methodologies hereof. Moreover, other representations of discrete derivatives, such as those obtained from linear or higher-order finite-elements or Fourier interpolation with other compact or spectral basis sets, as known in the mathematical arts, and can be used in determining derivatives in the devices, systems, and methods hereof. The representative discrete formulations set forth herein are for a finite differences scheme.

In the case of a discrete derivative which is that obtained using Fourier interpolation, given the Fourier series representation h(x)=Σ_{q}\tilde{h}_{q} exp(iqx), where \tilde{h}(q) are commonly known as the Fourier coefficients and the sum runs over admissible wavevectors q which are an integer multiple of 2π/L where L is the sample size, a discrete derivative is obtained as

$$\frac{\partial }{\partial x} h ( x ) \approx \frac{D}{Dx} h ( x ) = {\sum }_{q} iq {\tilde{h}}_{q} exp ( iqx ) . \qquad ( 4 ( a ) )$$

One can also quantify the amplitude of higher derivatives as follows

$$\text{?} = {〈 {( \frac{{D}^{α}}{{Dx}^{α}} h ( x ) )}^{2} 〉}^{1 / 2} \qquad ( 5 )$$

$$\text{?} \text{indicates text missing or illegible when filed}$$

where α=2 yields the rms curvature. A discrete formulation of the second derivative using a finite differences scheme is

$$\frac{{D}^{2}}{{Dx}^{2}} h ( x ) = \frac{h ( x + Δ x ) - 2 h ( x ) + h ( x - Δ x )}{Δ {x}^{2}} . \qquad ( 6 )$$

This expression is called the second-order central-differences approximation. Again, this can be interpreted as fitting a second-order polynomial to the three points x−Δx, x, and x+Δx, and interpreting the (constant) second derivative of this polynomial as the approximate second derivative of the discrete set of data points. The third derivative is given by

$$\frac{{D}^{3}}{{Dx}^{3}} h ( x ) = \frac{h ( x + 2 Δ x ) - 3 h ( x + Δ x ) + 3 h ( x ) - h ( x - Δ x )}{Δ {x}^{3}} , \qquad ( 7 )$$

which again can be interpreted in terms of fitting a cubic polynomial to (four) collocation points.

In a number of embodiments, the first-order or higher-order derivatives are determined over multiple distance scales for lines of one or more scans of the surface or for areas of one or more scans of the surface. Discrete derivatives for lines of the one or more scans for points xₖ on the lines may be written as a weighted sum over the collocation points xₖ, by the general formula:

$$\frac{{D}^{α}}{{Dx}^{α}} h ( \text{?} ) = \frac{1}{Δ {x}^{α}} \text{?} h ( \text{?} ) \qquad ( 8 )$$

$$\text{?} \text{indicates text missing or illegible when filed}$$

wherein α is the order of the derivative, Δx is the smallest possible scale, and cₗ^{(a)} set forth a stencil of the derivative, and wherein the derivative is measured at a distance scale [symbol] =αηΔx. As clear to those skilled in the art, the summation does not run to infinity in actual application. For example, the stencils for the α=1, 2 and 3 in a number of embodiments hereof are

c₀⁽¹⁾=−1,c₁⁽¹⁾=1, (9)

c₀⁽²⁾=−2,cₖ₁⁽²⁾=1 and (10)

c₀⁽³⁾=3,c₁⁽³⁾=−3,c₋₁⁽³⁾=−1,c₂⁽³⁾=1, (11)

wherein all other cₗ^{(a)} are zero. As clear to those skilled in the art, higher-order derivatives lead to wider stencils.

The discrete derivatives of the preceding section are all defined on the smallest possible scale that is given by the sample spacing Δx and have an overall width of ααx. It is straightforward to attach an explicit scale to these derivatives, by evaluating Eq. (8) over a sample spacing ηΔx (with integer η) rather than Δx,

$$\frac{{D}_{( η )}^{α}}{{D}_{( η )} {x}^{α}} h ( x ) ≡ \frac{1}{( η Δ x \text{?}} \text{?} . \qquad ( 12 )$$

$$\text{?} \text{indicates text missing or illegible when filed}$$

The factor η is referenced herein as the scale factor. The corresponding derivative is measured at the distance scale [symbol] =αηΔx.

As set forth above, the first-order or higher-order derivatives may alternatively be determined for areas (that is, in two dimensions) of the one or more scans of the surface. The first-order or higher-order derivatives in two dimensions are, for example, provided by the formula:

$$\frac{{D}_{( η )}^{α + β}}{{D}_{( η )} {x}^{α} {D}_{( η )} {y}^{β}} h ( x , y ) ≡ \frac{1}{{( η Δ x )}^{α} {( η Δ y )}^{β}} {\sum }_{l = - ∞}^{∞} {\sum }_{m = - ∞}^{∞} {c}_{lm}^{( α , β )} h ( + η l Δ x , y + η m Δ y ) \qquad ( 12 a )$$

wherein α and β are orders of derivatives in the x and y directions, respectively, and cₗₘ^{(α, β)} set forth a stencil. In two dimensions, there may be mixed orders of derivatives in the x and y direction. As described above, the summation does not run to infinity in actual application.

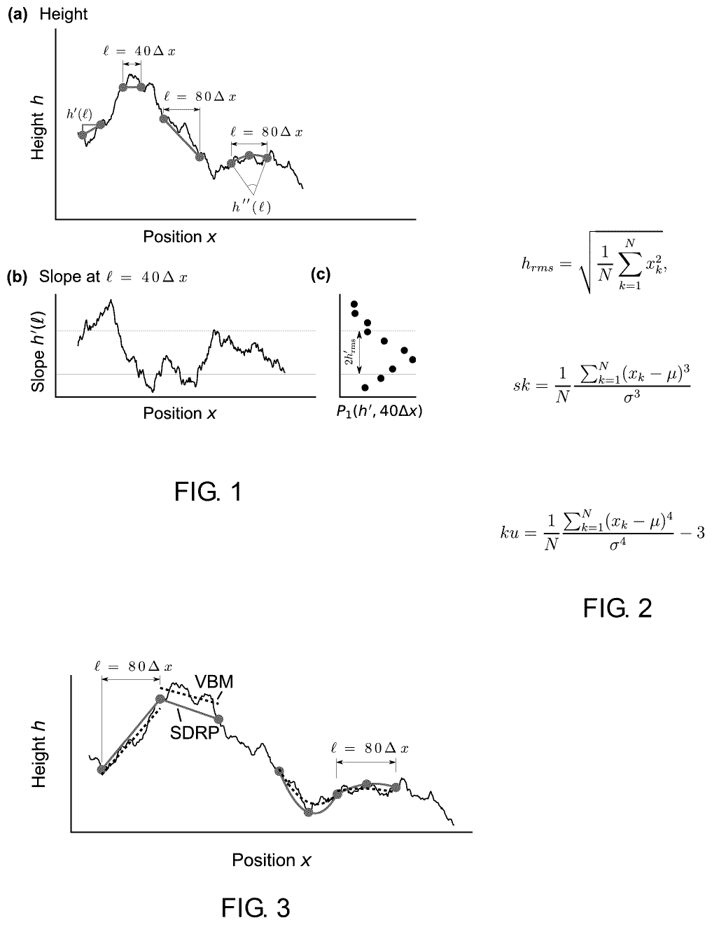

FIG. 1 a illustrates the above-discussed concept. For a simple right-differences scheme as given by Eq. (4), the scale-dependent first derivative is simply the slope of the two points at distance [symbol] . In panel (a) of FIG. 1, a representative line scan is illustrated showing the computation of slopes h′( [symbol] ) and curvatures h″( [symbol] ) from finite differences. A scale can be attached to this computation by computing these finite differences at different distances [symbol] , shown for [symbol] =40Δx and [symbol] =80Δx where Δx is the sample spacing. Similarly, the curvature at a finite scale [symbol] is given by fitting a quadratic function through three points spaced at a distance [symbol] /2. Panel (b) illustrates local slope, obtained at a distance scale of [symbol] =40Δx for the line scan shown in panel (a). The slope is defined for each sample point since one can compute it for overlapping intervals. Panel (c) illustrates the distribution of the local slope obtained from the slope profile shown in panel (b). The rms slope for this length scale is the width of this distribution. For the second derivative given by Eq. (6), one fits a quadratic function through three points with overall spacing [symbol] and the curvature of this function is the scale-dependent second derivative.

Scale-dependent roughness parameters or SDRPs hereof are defined as

$${h}_{SDRP}^{( α )} ( α η Δ x ) = 〈 {( \frac{{D}_{( η )}^{α}}{{D}_{( η )} {x}^{α}} h ( x ) )}^{2} \text{?} . \qquad ( 13 )$$

$$\text{?} \text{indicates text missing or illegible when filed}$$

This new function defines a series of descriptors for the surface that are analogous to the traditional rms slope (h_{SDRP}⁽¹⁾≡h′_{SDRP}) and to the rms curvature (h_{SDRP}⁽²⁾≡h″_{SDRP}). However, instead of being a single scalar value, each represents a curve as a function of the distance scale [symbol] =α72 Δx.

The distance scale [symbol] is only clearly defined for the stencils of lowest truncation order. In the representative case of finite differences, for the n-th derivative, those can be interpreted as fitting a polynomial of order n to n+1 data points (see FIG. 1, panel (a)). The n-th derivative of this polynomial is then a constant over the width of the stencil. That width must then equal the distance scale [symbol] . Higher truncation orders can be interpreted as fitting a polynomial of order m>n to m+1 data points. The n-th derivative is not constant over the stencil and it is not clear what the corresponding length scale is. In a number of representative examples hereof, only stencils of lowest truncation order where the distance scale is clear were used.

For non-periodic topographies one should take care to include only derivatives that one can actually compute, that is, where the stencil remains in the domain of the topography. This is indicated by the subscript “domain” in Eq. (13). The rms value, such as the one defined in Eq. (13), characterizes the amplitude of fluctuations, or the width of the underlying distribution function. Rather than looking at such a single parameter, one can also determine the full scale-dependent distribution. Formally that distribution can (in a single dimension) be written as

$$\text{?} η ) = 〈 δ ( \text{?} - \frac{{D}_{( η )}^{α}}{{D}_{( η )} {x}^{α}} h ( x ) ) 〉 \qquad ( 14 )$$

$$\text{?} \text{indicates text missing or illegible when filed}$$

wherein δ is the Dirac δ function, and χ is the value of the derivative of order α, and the angle brackets [symbol] ⋅ [symbol] indicate an average over position x. The δ function may, for example, be broadened into individual bins and the number of occurrences of a certain derivative value may be counted.

To illustrate this concept on the example of the slope (α=1), panel (b) shows the scale-dependent derivative at [symbol] =40Δx of the line scan shown in panel (a) of FIG. 1. The distribution function of the slopes at this scale, Pₗ(h′, 40Δx), is then obtained by counting the occurrence of a certain slope value. The resulting distribution is shown in panel (c) of FIG. 1.

The rms parameters defined in the previous section are the square roots of the second moments of this distribution,

h_{SDRP}^{(a)}(αηΔx)=[∫dχχ²Pₐ(χ:η)]^{1/2}. (15)

The second moment characterizes the underlying distribution fully only if this distribution is Gaussian. As, for example, described below scanning probe artifacts introduce deviations from Gaussianity that one can easily detect once we have the full distribution function.

The probability distributions of arbitrary derivatives (such as slope, curvature, or higher-order functions) hereof serve as an additional set of descriptors for a surface. The distributions are themselves scale dependent, but can be used to compute a wide variety of scale-dependent (statistical) parameters hereof, including higher cumulants. The statistical characterization of the distribution may, for example, be a second or higher cumulant thereof or a second or higher moment thereof. In a number of embodiments, the statistical characterization of the distribution is selected from the group consisting of variance, skewness, and kurtosis. Formulas for rms_{height} (hᵣₘₛ), skewness (sk) and kurtosis (ku) are provided in FIG. 2. In FIG. 2, xₖ is the k-th of N data points. In a number of embodiments, the commonly used variance, as well as the parameters of skewness sk and kurtosis ku were used to characterize probability distributions hereof. The skewness is the standardized third moment and the kurtosis is the standardized fourth moment, wherein μ is the mean and σ is the standard deviation in FIG. 2. For a normal distribution, the skewness is zero and the kurtosis is either zero (Fisher's definition or excess kurtosis) or three (Pearson's definition or non-excess kurtosis). The Fisher's definition is used in representative examples herein. In comparison to a normal distribution with the same variance, the skewness can be either positive or negative related, for example, to a shift to the left or right side as compared to a Gaussian distribution. The kurtosis is a measure of how flat or peaked a distribution is compared to the normal distribution with the same variance.

As set forth above, various methods for computing scale-dependent height (such as autocorrelation function (ACF), variable bandwidth methods (VBMs), power spectral density (PSD), and others) can be related to scale-dependent parameter analysis hereof. Such analyses can be extended to define yet another method for computing scale-dependent parameters described herein. In that regard, some form of scale-dependent parameters hereof can be computed using such methods, instead of using the definition set forth in Eq. (13), with approximately equivalent results in certain instances. Intuitively, the scale-dependent parameters hereof can be thought of as a general framework for analysis, which contains ACF, VBMs and PSD as special cases.

A common way of analyzing the statistical properties of surface topography is the height-difference autocorrelation function, which (as described above) is designated herein as ACF or A( [symbol] ). The ACF is defined as

$$\begin{matrix}A ( ℓ ) = \frac{1}{2} 〈 [ h ( x + ℓ ) - h ( x ) \text{?} 〉 \\ = 〈 \frac{1}{2} \text{?} ( x ) + \frac{1}{2} \text{?} ( x + ℓ ) - h ( x ) h ( x + ℓ ) 〉 .\end{matrix} \qquad ( 16 )$$

$$\text{?} \text{indicates text missing or illegible when filed}$$

Some authors refer to 2A( [symbol] ) as the structure function and use the term ACF for the bare height autocorrelation function [symbol] h(x)h(x+ [symbol] [symbol] . The height ACF and the height-difference ACF are related by

A( [symbol] )=hᵣₘₛ²−(h(x)h(x+ [symbol] )) (17)

The ACF has the limiting properties A(0)=0 and A( [symbol] →∞)=h²ᵣₘₛ.

Eq. (16) resembles the finite-differences expression for the first derivative, Eq. (4). Indeed, one can rewrite the ACF as

$$\text{?} ( η Δ x ) = \frac{1}{2} 〈 {[ \frac{\text{?}}{\text{?}} h ( x ) ]}^{2} 〉 {( η Δ x )}^{2} \qquad ( 18 )$$

$$\text{?} \text{indicates text missing or illegible when filed}$$

using the scale-dependent derivative. The scale-dependent rms slope then becomes

h′_{SDRP}( [symbol] )=[2A( [symbol] )]^{1/2}/ [symbol] . (19)

The height-difference ACF can thus be used to compute the scale-dependent slope introduced above.

One may further show that one can also express higher-order derivatives in terms of the ACF. Using the stencil of the second derivative given in Eq. (6), the scale-dependent second derivative can be written as

$$\text{?} ( ℓ ) = \frac{4}{{ℓ}^{2}} {〈 {[ h ( x + ℓ / 2 ) - 2 h ( x ) + h ( x - ℓ / 2 ) ]}^{2} 〉}^{1 / 2} . \qquad ( 20 )$$

$$\text{?} \text{indicates text missing or illegible when filed}$$

The above expression can be rewritten as

$$\text{?} ( ℓ ) = \frac{4}{{ℓ}^{2}} {〈 6 {h}^{2} ( x ) - 8 h ( x ) h ( x + ℓ / 2 ) + 2 h ( x ) h ( x + ℓ ) 〉}^{1 / 2} . \qquad ( 21 )$$

$$\text{?} \text{indicates text missing or illegible when filed}$$

Eq. (17) may be used to introduce the ACF into this expression, yielding

h″_{SDRP}( [symbol] )=4[8A( [symbol] /2)−2A( [symbol] )]^{1/2}/ [symbol] ². (22)

Similarly, the scale-dependent third derivative from the stencil given in Eq. (7) becomes

$$\text{?} ( ℓ ) = \frac{27}{\text{?}} \text{?} 30 A ( ℓ / 3 ) - 12 A ( 2 ℓ / 3 ) + 2 A ( ℓ ) \text{?} . \qquad ( 23 )$$

$$\text{?} \text{indicates text missing or illegible when filed}$$

One can therefore relate the scale-dependent root-mean-square slope, curvature, or any other higher-order derivative to the ACF using the relationship developed herein.

SDRPs hereof may also be derived based on a different notion of scale. The discussion leading up to Eq. (13) does not involve the length L of the line scan. That length is relevant only when it comes to determining an upper limit for the stencil length [symbol] =αηΔx, which is the notion of scale in a measurement based on Eq. (13). Alternatively, one could interpret L as the relevant scale, and study scale-dependent roughness by varying L. This interpretation leads to a class of methods which have been referred to as scaled windowed variance methods or variable bandwidth methods (VBMs). Members of this class of methods differ only in the way that the data is detrended and have been given a variety of names including: bridge method (attributed to Mandelbrot); roughness around the mean height (MHR; sometimes termed VBM); detrended fluctuation analysis (DFA); and roughness around the rms straight line (SLR).

In all cases, one performs multiple roughness measurements on the same specimen (or the same material) but with different scan sizes L. Plotting the rms height hᵣₘₛ, from these measurements versus scan size L, or the rms slope h′ versus scan resolution (the smallest measurable scale) yields insights into the multiscale nature of surface topography.

These methods can be generalized for the analysis of single measurements. Consider a line scan h(x) of length L. The scan is partitioned into ζ≥1 segments of length [symbol] (ζ)=L/ζ (with [symbol] ≤L now being the relevant scale). The dimensionless number ζ, which is referred to herein as the magnification, defines the scale. Some use sliding windows rather than exclusive segments.

The VBM considers the rms height fluctuations in each of the segments. In that regard, one computes the standard deviation of the height h_{VBM,i}(ζ) within segment i at magnification, and then takes the average over all i to compute a scale-dependent h_{VBM}(ζ). Some investigators have tilt-corrected the individual segments. In that case, each segment is detrended by subtracting the corresponding mean height and slope (obtained by linear regression of the data in the segment) before computing h_{VBM,i}(ζ). That approach is called the DFA while, without tilt correction, it is called MHR. In the bridge method, the connecting line between the first and last point in each segment is used for detrending.

These VBMs are similar to the SDRP. When computing the slope in the SDRP, one computes it by simply connecting the two boundary points at x=i [symbol] (ζ) and x=(i+1) [symbol] (ζ) with a straight line, as is done in the bridge method. This method is distinct from DFA, which uses all data points between the two boundary points and fits a straight line using linear regression. Detrending can be generalized to higher-order polynomials, but this has not been reported in the literature. The relationship between SDRP and VBMs with detrending of order 1 and 2 is conceptually illustrated in FIG. 3, which illustrates the computation of scale-dependent roughness parameters from the variable bandwidth method (VBM). While in finite differences, the slope is computed between two points at distance [symbol] , in the VBM one fits a trend line to a segment of width [symbol] . Similarly for the second derivative, the finite-differences estimation fits a quadratic function through three points while in the VBM one fits a quadratic trend line through all data points in an interval of length [symbol] .

In DFA, the trend line is simply used as a reference for the computation of fluctuations around it. The coefficients of the detrending polynomial can also be used to analyze how the slope and curvature of the surface depend on scale. This yields an alternative measure of the scale-dependent rms slope, h′_{VBM}(ζ), obtained at magnification ζ or distance scale [symbol] =L/ζ, h′_{VBM}(ζ), which is simply the standard deviation of slopes obtained within all segments i at a certain magnification ζ. It is shown below that this scale-dependent slope is very similar to the slope obtained from the SDRP.

One can use the above-discussed observation to extend the DFA to higher-order derivatives. Rather than fitting a linear polynomial in each segment, one may detrend using a higher-order polynomial. For extracting a scale-dependent rms curvature, one may fit a second-order polynomial to the segment and interpret twice the coefficient of the quadratic term as the curvature. The standard deviation of this curvature over the segments then gives the scale-dependent second derivative, h″_{VBM}(ζ). As described above, FIG. 3 illustrates this concept, again in comparison to the SDRP, which for the second-order derivative fits a quadratic function through just three collocation points.

An alternative route of thinking about VBMs is that they use a stencil whose number of coefficients equals the segment length. The stencil can be explicitly constructed from least squares regression (at each scale) of the polynomial coefficients. The closest equivalent to the SDRP would then be the respective VBM that uses sliding (rather than exclusive) segments. However, even in this case, a remaining difference is that SDRP uses stencils of identical number of coefficients at each scale. In studies hereof, a VBM that uses nonoverlapping segments was used.

The above discussion demonstrates that the various methods for computing scale-dependent height (such as VBM, DFA, and others) can be thought of as a special case of SDRP analysis: where the scale-dependent detrending occurs only for at most linear trend lines. Using relationships developed herein as set forth above, Those analyses can be extended to define another method for computing or estimating SDRPs.

Another way to indirectly arrive at SDRPs is using the power spectral density (PSD), which is another common tool for the statistical analysis of topographies. Underlying the PSD is a Fourier spectral analysis, which approximates the topography map as the series expansion

$$h ( x ) = \text{?} ( x ) , \qquad ( 24 )$$

$$\text{?} \text{indicates text missing or illegible when filed}$$

where ϕₙ(x) are called basis functions. The Fourier basis is given by

ϕₙ(x)=exp(iqₙx), (25)

with qₙ=2πn/L, where L is the lateral length of the sample. The inverse of Eq. (24) gives the expansion coefficients aₙ which are typically computed using a fast Fourier-transform algorithm. The PSD is then obtained as

C^{1D}(qₙ)=L|aₙ|². (26)

Fourier spectral analysis is useful because a notion of scale is embedded in the definition Eq. (25): The wavevectors qₙ describe plane waves with wavelength λ₂=2π/qₙ.

This basis leads to spectral analysis of surface topography and derivatives are straightforwardly computed from the derivatives of the basis functions,

$$\\ \begin{matrix}\frac{\partial }{\partial x} ϕ \text{?} ( x ) = iq \text{?} ϕ \text{?} ( x ) and & ( 27 )\end{matrix}$$

$$\\ \begin{matrix}\frac{{\partial }^{2}}{{\partial }^{2} x} ϕ \text{?} ( x ) = - q \text{?} ϕ \text{?} ( x ) . & ( 28 )\end{matrix}$$

$$\\ \text{?} \text{indicates text missing or illegible when filed}$$

One can write the Fourier-derivative generally as

$$\\ \begin{matrix}\frac{\partial \text{?}}{\partial x \text{?}} ϕ \text{?} ( x ) = \text{?} ( q \text{?} ) ϕ \text{?} ( x ) & ( 29 )\end{matrix}$$

$$\\ \text{?} \text{indicates text missing or illegible when filed}$$

With [symbol] ₁(qₙ)=iqₙ for the first derivative and [symbol] ₂(qₙ)=−qₙ² for the second derivative. The [symbol] ₐ(qₙ) are complex numbers that we will call the derivative coefficients.

The rms amplitude of fluctuations can be obtained in the Fourier picture from Parseval's theorem, that turns the real-space average in Eq. (5) into a sum over wavevectors,

$$\\ \begin{matrix}h \text{?} = {[ \text{?} {\vert \text{?} ( q \text{?} ) a \text{?} \vert}^{2} ]}^{1 / 2} . & ( 30 )\end{matrix}$$

$$\\ \text{?} \text{indicates text missing or illegible when filed}$$

The notion of a scale-dependence can be introduced in the Fourier picture by removing the contribution of all wavevectors |qₙ|>q_{c} larger than some characteristic wavevector q_{c} (that is, setting the corresponding expansion coefficients an to zero). This means there are no longer short wavelength contributions to the topography. The process is referred to herein as Fourier filtering. Fourier filtering can be used to introduce a scale-dependent roughness parameter, for example,

$$\\ \begin{matrix}h \text{?} ( q \text{?} ) = {[ \text{?} {\vert \text{?} ( q \text{?} ; q \text{?} ) \vert}^{2} C \text{?} ( q \text{?} ) ]}^{1 / 2} & ( 31 )\end{matrix}$$

$$\\ \text{?} \text{indicates text missing or illegible when filed}$$

with [symbol] ₐ^{F}(qₙ; q_{c})=Θ(q_{c}−|qₙ|) [symbol] ₐ(qₙ) that is referred to as the Fourier-filtered derivative and Θ(x) is the Heaviside step function. Eq. (31) has been expressed in terms of the PSD, which is typically obtained using a windowed topography if the underlying data is nonperiodic. In examples hereof, a Hann window was applied before computing the scale-dependent derivatives from the PSD.

Fourier-filtering and finite-differences may be related. One first interprets the finite-differences scheme in terms of a Fourier analysis. One then applies the finite differences operation to the Fourier basis Eq. (25). This yields

$$\\ \begin{matrix}\frac{D \text{?}}{D \text{?} x \text{?}} ϕ \text{?} ( x \text{?} ) = \text{?} ( q \text{?} ; η ) ϕ \text{?} ( x \text{?} ) with & ( 32 )\end{matrix}$$

$$\\ \begin{matrix}\frac{D \text{?}}{D \text{?} x \text{?}} ϕ \text{?} ( x \text{?} ) = \text{?} ( q \text{?} ; η ) ϕ \text{?} ( x \text{?} ) . & ( 33 )\end{matrix}$$

$$\\ \text{?} \text{indicates text missing or illegible when filed}$$

Note that the right hand side of Eq. (32) is fully algebraic. In that regard, it no longer contains derivative operators. The [symbol] ^{s}(qₙ; η) are (complex) numbers. Inserting these derivative coefficients into Eq. (31) yields Eq. (13). The above discussion unifies the description of (scale-dependent) derivatives in the Fourier basis and finite-differences in terms of the derivative coefficients [symbol] ₐ.

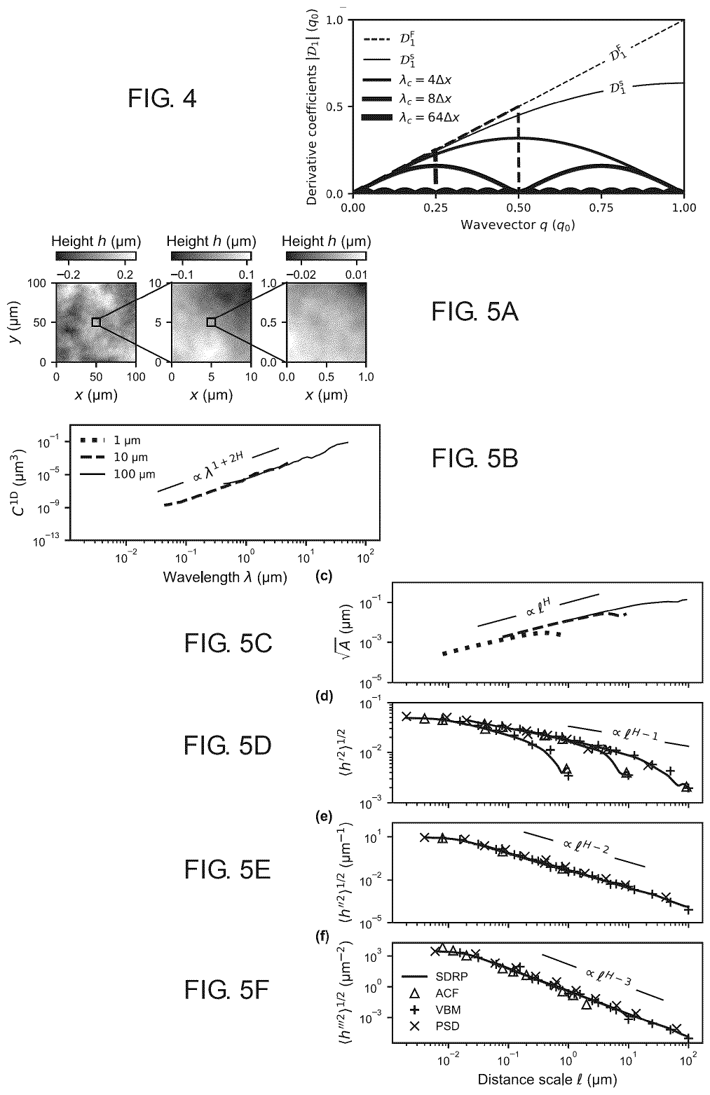

The remaining question is how the scale l used to compute the finite-differences relates to the wavevector q_{c} used in Fourier-filtering. FIG. 4 shows [symbol] ₁^{F}(λ_{c}) (Fourier-filtered derivative) and D₁^{s}( [symbol] ) (derivative coefficients for finite differences) for different values of l and λ_{c}. As illustrated, the coefficients agree at small wavevectors q. The location of the maximum of these derivative coefficients agrees if ηΔx≡ [symbol] /α=λ_{c}/2=π/q_{c}. For first derivatives (α=1), [symbol] =Δx. This is the Nyquist sampling theorem, which states that the shortest wavelength we can resolve is λ_{c}=2Δx. Thus, to compare SDRP, VBM and PSD, one needs to choose a filter cutoff of q_{c}=απ/ [symbol] in the latter. In the case of SDRP, the (soft) cutoff emerges implicitly from the finite-difference formulation.

It has thus been shown that the SDRPs, which were defined in real-space above, can be computed or estimated in frequency-space using the PSD. However, frequency-space calculations have the shortcomings that nonperiodic topographies need to be windowed, and a filter cutoff needs to be applied.

The concepts presented above were applied to a synthetic self-affine topography. The topography consists of three virtual “measurements” of a large (65,536×65,536 pixels) self-affine topography generated with a Fourier-filtering algorithm. See T. D. B. Jacobs, T. Junge, L. Pastewka, Quantitative characterization of surface topography using spectral analysis, Surf. Topogr. Metrol. Prop. 5 (2017) 013001; and S. B. Ramisetti, C. Campaña, G. Anciaux, J.-F. Molinari, M. H. Müser, M. O. Robbins, The autocorrelation function for island areas on self-affine surfaces, J. Phys. Condens. Matter 23 (2011) 215004. In that algorithm, one superposes sine waves with uncorrelated random phases and amplitudes scaled according to a power-law. On the pixel at position \vec{x}ᵢⱼ=(xᵢ, yⱼ), the height can be

$$\\ \begin{matrix}h \text{?} = \text{?} A \text{?} sin ( \vec{q} \text{?} \cdot \vec{x} \text{?} + ϕ \text{?} ) , & ( 34 )\end{matrix}$$

$$\\ \text{?} \text{indicates text missing or illegible when filed}$$

where \vec{q}ₐ=2π/L(k,l) is the wavevector and L is the period of the topography. The phases ϕₖₗ are uncorrelated and uniformly distributed between 0 and 2π. The amplitudes Aₖₗ are uncorrelated Gaussian random variables with variance proportional to |\vec{q}ₙ|^{-2-2H}. The sum runs only over wavevectors smaller than the short-wavelength cutoff qₛ=2π/λₛ. The (two-dimensional) PSD of the surface is the square of the amplitudes Aₖₗ and is 0 for wavelengths below λₛ. The surface was generated with Hurst exponent H=0.8, cutoff wavelength λₛ=10 nm, pixel size Δx=Δy=2 nm and physical size L=131 μm. This surface was subsampled in three blocks of 500×500 pixels at overall lateral sizes of 100 μm×100 μm, 10 μm×10 μm and 1 μm×1 μm to emulate measurement at different resolution. Each of these virtual measurements is nonperiodic and independently tilt-corrected. The data for the three subsampled topographies is available online.

FIG. 5A shows the topography map of those three emulated measurements. The measurements zoom subsequently into the center of the topography. The one-dimensional PSDs (C^{1D}, FIG. 5B) of the three topographies align well, showing zero power below the cutoff wavelength of λₛ. The PSD is displayed as a function of wavelength λ=2π/q where q is the wavevector, which facilitates comparison with the real-space techniques introduced above, and also wavelengths are more intuitively understandable than wavevectors. Since the topography is self-affine, the PSD scales as C^{1D}∝λ^{1+2H} as indicated by the solid line.

The square root of ACF is shown in FIG. 5C. The ACF and all other scale-dependent quantities reported below are obtained from averages over adjacent line scans, that is, from one-dimensional profiles rather than two-dimensional area scans. This is compatible with how C^{1D} is computed. The ACFs from the three measurements line up and follow \sqrt{A}∝ [symbol] ^{H} (see solid black line in FIG. 5C). The ACF does not drop to zero for [symbol] < [symbol] ₛ≡λₛ/2 as the PSD did. This behavior becomes clearer by inspecting the scale-dependent slope h′_{SDRP}( [symbol] )=\sqrt{2A()}/ [symbol] that saturates at a constant value for [symbol] < [symbol] ₛ. This is the true rms slope that is computed when all scales are considered. For large [symbol] , the rms slope scales as h′_{SDRP}∝ [symbol] ^{H-1}. (solid black line in FIG. 5D).

The scale-dependent curvature h″SDRP( [symbol] ) in illustrated in FIG. 5E. Like the rms slope, the curvature saturates for [symbol] < [symbol] ₛ to the “true” small-scale value of the curvature. The curvatures of the three individual measurements again line up and follow h″_{SNDP}( [symbol] )∝ [symbol] ^{H-2} because of the self-affine character of the overall surface. The rms curvature computed from the ACF (Eq. (22)) is strictly only applicable to periodic topographies, but in the present numerical experiments the ACF agrees with the original definition of the SDRPs (Eq. (13)) within the thickness of the line. The errors occur at large distance scales and can, in principle, lead to negative values of h″_{SDRP}, but this was not observed in the numerical data presented herein.

In the derivation above, alternative routes were presented for obtaining scale-dependent roughness parameters from the VBM and PSD. The plus signs (+) in FIGS. 5D and 5E show the rms slope and curvature obtained using the VBM, while the crosses (x) show the results obtained using the PSD. They align well with the respective parameters obtained from the SDRP analysis and only deviate at large scales. In summary, all three routes (ACF, VBM, PSD) for obtaining SDRPs (that is, scale-dependent parameters determined from a second cumulant and/or moment or variance) are validated and lead to results that are consistent with those computed using the original definition (Eq. (13)). An advantage of the SDRP, ACF and the VBM over the PSD is that they are directly (without windowing) applicable to nonperiodic data. Moreover, scale-dependent parameters or statistical characterizations hereof that are determined from a third or higher cumulant or a third or higher moment cannot be determined from parameters such as ACF, VBM, and PSD.

Four independent ways of obtaining scale-dependent slopes, curvatures and higher-order derivatives have thus been demonstrated. All four routes constitute novel uses of the underlying analysis methodology. The primary tool in a number of the studies below are the SDRP. A broader importance of using scale-dependent slopes and curvatures over the “bare” ACF, VBM or PSD is that it is straightforward to interpret the meaning of those parameters. All have an intuitive understanding of the meaning of slopes and curvatures, whereas it is difficult to ascribe a geometric meaning to a value of, for example, the PSD.

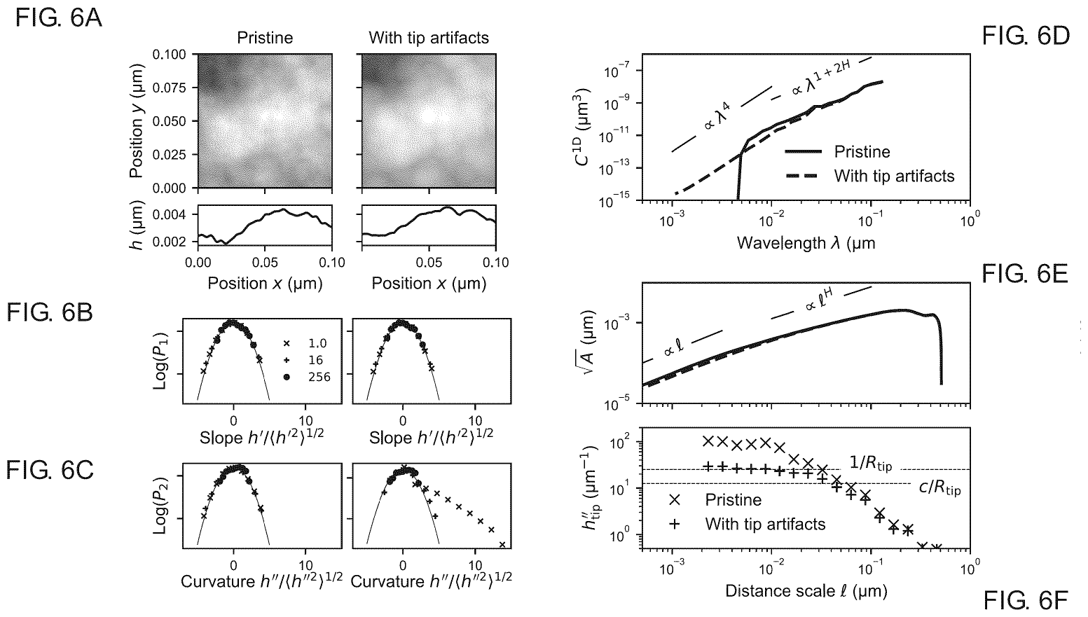

In the analysis of tip artifacts, the power of the SDRP to compute the full underlying distribution of arbitrary derivatives is utilized in a number of studies hereof. FIG. 6A shows two computer-generated nonperiodic topographies of size 0.1 μm×0.1 μm. The first topography is pristine and was generated using the Fourier-filtering algorithm mentioned above. As in the previous example, it was ensured the scan is not periodic by taking a section of a larger (0.5 μm) periodic scan. The second topography contains tip artifacts and was obtained from the pristine surface using a nonlinear procedure. In that regard, for every location (xᵢ, yᵢ) on the topography, one lowers a sphere with radius Rₜᵢₚ (here 40 nm) towards a position (xᵢ, yᵢ, zᵢ) until the sphere touches the pristine topography anywhere. The resulting z-position zᵢ of the sphere is then taken as the “measured” height of the topography. This topography was discussed in T. D. B. Jacobs, T. Junge, L. Pastewka, Quantitative characterization of surface topography using spectral analysis, Surf. Topogr. Metrol. Prop. 5 (2017) 013001 and the data files are available online. The two curves underneath the maps in FIG. 6A are cross-sections through the middle of the respective topography.

It is clear from the data in FIG. 6A that the scanning probe smoothens the peaks of the topography. Indeed the curvature near the peaks must be equal to −1/Rₜᵢₚ. Conversely, the valleys look like cusps that originate from the overlap of two spherical bodies. These cusps are sharp and should lead to large (in theory unbounded, but in practice bounded by resolution and noise) positive values of the curvature. It has been observed that tip artifacts should lead to PSD C^{1D}(q)∝q⁻⁴, which is precisely a result of the cusps in the topography. In that regard, the Fourier transform of a triangle scales as q⁻², such that the PSD∝q⁻⁴. The observation has been demonstrated numerically.

FIG. 6B shows the scale-dependent slope distribution P₁(h′, [symbol] ), normalized by the rms slope at the respective scale. The black solid line shows a Gaussian distribution (of unit width) for reference. It is clear that both the pristine topography (left columns) and the topography with tip-radius artifacts (right column) follow a Gaussian distribution for the scale dependent slopes across scales from 1 nm to 256 nm shown in the figure.

The situation is different for the scale-dependent curvature, shown in FIG. 6C. While the pristine surface (left column) follows a Gaussian distribution, the topography with tip-radius artifacts is only Gaussian for larger scales ( [symbol] =16 nm and 256 nm). There is a clear deviation at the smallest scales, showing an exponential distribution for positive curvature values, corroborating the empirical discussion above that cusps leads to large positive values for the curvature. These cusps lead to a PSD∝q⁻⁴∝λ⁴. FIG. 6D shows the PSDs of both topographies. The artifacted surface indeed crosses over to C^{1D}∝λ⁴ at a wavelength of λ˜20-40 nm.

The cross-over to λ⁴ is subtle and difficult to detect in measured data. Other measures, such as the ACF shown in FIG. 6E, are unsuitable to detect these artifacts. The region where the C^{1D}∝λ⁴ shows up as a linear region in the square root of the ACF, (A∝ [symbol] )^{1/2}. The exponent of 1 from that region is too close to the exponent of H=0.8 to be clearly distinguishable. A tip-radius reliability cutoff has been previously suggested, where the scale-dependent rms curvature was compared to the tip curvature. An additional metric that is intended to more accurately detect the onset of the tip-radius artifact may now be established.

Rather than computing the width of the distribution as do the rms measures, one may now ask the question of what is the minimum curvature value found at a specific scale [symbol] . One may therefore evaluate

$$\\ \begin{matrix}h \text{?} ( ℓ ) = - \text{?} [ \frac{D \text{?}}{D \text{?} {x}^{2}} h ( x \text{?} ) ] . & ( 35 )\end{matrix}$$

$$\\ \text{?} \text{indicates text missing or illegible when filed}$$

The crosses in FIG. 6F show this quantity for the pristine and the artifacted surface. It is clear that at small scales the curvature of the pristine surface is larger than the artifacted one. Additionally, the artifacted surface settles to h″ₘᵢₙ( [symbol] )≈1/Rₜᵢₚ, as [symbol] →0, which indicates that the curvature of the peaks on the artifacted surface is given by the tip radius and that, in principle, the tip radius can be deduced from h″ₘᵢₙ. However, in real AFM data, h″ₘᵢₙ in has no well-defined [symbol] →0 limit because there are noise sources not considered in the simulated measurement. The tip radius thus needs to be determined from auxiliary measurements.

For each tip radius and surface topography, there is a critical length scale [symbol] ₜᵢₚ below which AFM data is unreliable. One may estimate [symbol] ₜᵢₚ by numerically solving

h″ₘᵢₙ( [symbol] ₜᵢₚ)=c/Rₜᵢₚ (36)

for [symbol] ₜᵢₚ using a bisection algorithm. The empirically determined factor c needs to be close to or slightly smaller than unity. FIG. 6F shows this condition as a dashed horizontal line. Note that [symbol] ₜᵢₚ depends both on the tip radius and the curvature of the measured surface: measurements on rough surfaces have more tip artifacts than measurements on smooth surfaces because a tip that can conform to the valleys of a smooth surface may not be able to sample the valleys on a rougher surface. The scale [symbol] ₜᵢₚ is also indicated in the ACF (FIG. 6E) and in the PSD. The factor c=½ was chosen such that λₜᵢₚ marks the crossover from artifacted C^{1D}∝λ⁴ to the pristine C^{1D}∝λ^{1+2H}. The same factor is used below when analyzing experimental data for which there is no “pristine” measurement available for comparison. The proposed measure is useful because it can be robustly and automatically carried out on large sets of measurements; by contrast, the detection of C^{1D}∝λ⁴ is difficult because fitting exponents requires data over at least a decade in length and carries large errors.

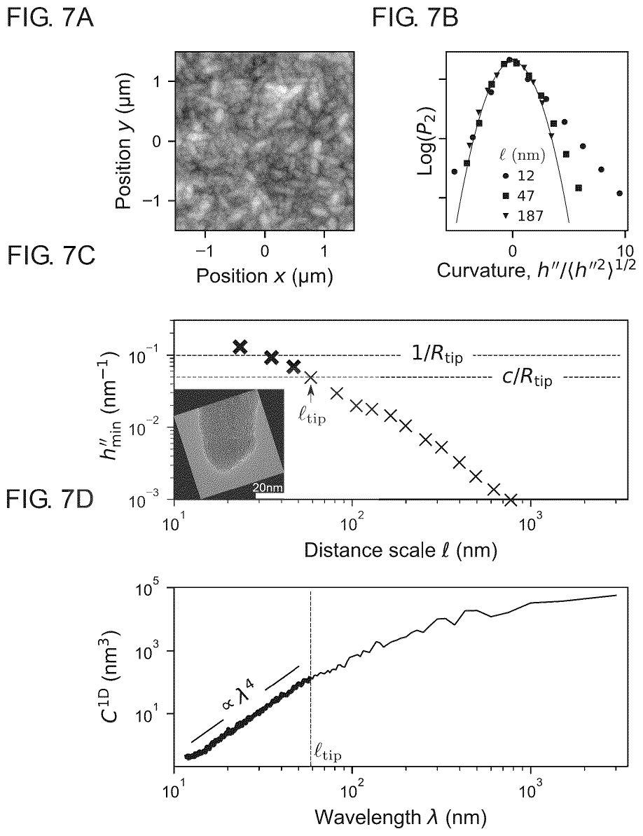

In another example, an experimental analysis was performed on an ultra-nanocrystalline diamond (UNCD) film that has been described in detail in A. Gujrati, S. R. Khanal, L. Pastewka, T. D. B. Jacobs, Combining TEM, AFM, and profilometry for quantitative topography characterization across all scales, ACS Appl. Mater. Interf. 10 (2018) 29169. FIG. 7A shows a single representative AFM scan of that surface that is available online. The peaks have rounded tips similar to the synthetic scan shown in FIG. 6A. The curvature distribution (FIG. 7B) also has a similar characteristic to the synthetic topography (see FIG. 6C). At large scales, the distribution is approximately Gaussian (shown by the solid black line). At smaller scales, deviations to higher curvature values are observed, indicative of the cusps that are characteristic of tip artifacts. This was attributed to additional instrumental noise that contributes to small-scale features of the data.

The negative curvatures prevent the conclusive determination of the tip radius from the scale-dependent tip curvature (FIG. 7C). Unlike the synthetic surfaces, the scale-dependent tip curvature h″min( [symbol] ) (FIG. 6F) does not saturate to a specific value at small distances [symbol] . Instead, we determined the radius of AFM tip from auxiliary transmission electron microscopy (TEM) measurements (FIG. 7C inset). For the measured Rₜᵢₚ=10 nm, one can identify the region where h″ₘᵢₙ( [symbol] )>1/(2Rₜᵢₚ) as unreliable, leading to a lateral length-scale of around [symbol] ₜᵢₚ≈60 nm below which the data is no longer reliable. The PSD (FIG. 7D) shows) λ⁴ scaling below the characteristic wavelength [symbol] ₜᵢₚ.

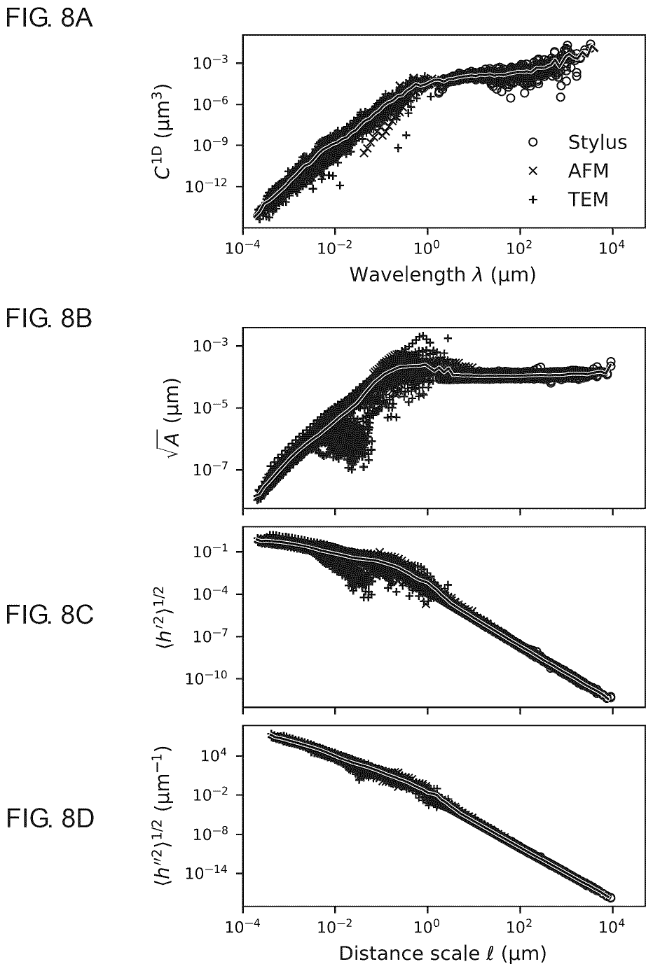

After examining tip-radius effects on single measurements, SDRPs were then applied to the full experimental dataset of A. Gujrati id., wherein a total of 126 individual measurements from three different instruments, a stylus profilometer, an AFM and a TEM, were combined to extract the power spectrum of the surface over eight orders of magnitude. FIGS. 8A through 8D shows the PSD, ACF, rms slope and rms curvature, respectively, for each individual measurement as well as an average curve representative of the whole surface. For each tip-based measurement (stylus and AFM), the critical scale [symbol] ₜᵢₚ was computed using Eq. (36) as above data on scales below tip were excluded. The good overlap of the AFM data with the TEM data confirms that this procedure removed tip artifacts. The full data set shows clear regions where the PSD C^{1D}∝q⁻⁴.

As shown in FIGS. 8A through 8D, all four methods can be used to “stitch together” the data from a large set of measurements to obtain the resulting SDRP of the underlying physical surface. The ACF (FIG. 8B) and rms slope h′ᵣₘₛ (FIG. 8C) of the TEM measurements curve down at large [symbol] , an effect also seen (but less pronounced) in the synthetic data of FIGS. 5C and 5D, which is a consequence of tilt correction that enforces zero slope at the size of the overall measurement, hence forcing h′ᵣₘₛ to drop towards zero. While more sophisticated schemes for tilt correction could be devised to eliminate this long-wavelength artifact, the rms curvature h″ᵣₘₛ is free of this artifact because it is unaffected by local tilt of the measurement. It may thus be important to look at a combination of the scale-dependent analysis techniques rather than relying on a single technique.

The novel SDRP analysis hereof may be considered a generalization of commonly used roughness metrics. The SDRP approach may, for example, serves to harmonize competing roughness descriptors. However, it also offers advantages over such other methods, especially in terms of ease of calculation, intuitive interpretability, and detection of artifacts.

A number of further experiments were conducted with synthetic and experimental surfaces to study, for example, classification of rough surface topographies. Synthetic surfaces were generated as described above. The experimental surfaces were obtained by three different microscope technologies, allowing computation of scale-dependent roughness parameters or SDRPs hereof ranging from the nanoscale to the scale of millimeters. The applied measuring techniques were stylus profilometer, atomic force microscope (AFM), and transmission electron microscope (TEM). The set of parameters or feature vector, including the SDRPs and other scale-dependent parameters hereof, is meant to describe the topography in a general way. Hence, it can be applied to various contexts, instead of being optimized for just one. To validate the choice of statistical parameters, synthetic surfaces with two different Hurst exponents, and experimental surfaces with four different crystalline coatings were classified. In representative studies, the obtained sets of parameters were applied to the machine learning classification methods support vector machine (SVM) and Gaussian process classifier (GPC). In the machine learning context, parameters for the classification are called features, and a set of parameters refers to a feature vector. In a manner equivalent to the expression feature vector, the description data point is commonly used.

Feature vectors are built of suitable data representations for the machine learning algorithms. Thus, they may need to have reduced complexity compared to the whole measurements but still carry a meaningful amount of information about the surface topographies. Accordingly, a feature vector is a set of parameters, that was extracted from surface topographies. The parameters describe the statistical characterization of the height, slope, curvature, and 3^{rd} derivative as a function of the distance scale [symbol] =αηΔx. The statistical characterizations used in representative examples hereof were the variance (sometime referred to herein as SDRPs) as well as the skewness and kurtosis of the scale-dependent distribution (sometimes referred to herein collectively with variance as SDSPs or scale-dependent parameters). Those scale-dependent parameters were combined in a feature vector, which had the dimensionality from R²⁷ to R⁹⁹ in the conducted numerical experiments.

Since the features have different units (for example, height features are in m², and 3^{rd} derivative features are in m⁻²), evaluating them as absolute values can lead to overestimation or underestimation of some features. Features with larger values might have a larger influence on the model than features with lower values. Because of different units, this does not necessarily reflect the significance of those features in terms of classification. Therefore, standardization, also called scaling of the inputs or data normalization, can be applied to bring the features to the unit of standard deviation, by the equation

$$\\ \begin{matrix}{\hat{x}}_{ij} = \frac{{x}_{ij} - {\overline{x}}_{j}}{{σ}_{j}} . & ( 37 )\end{matrix}$$

The standardized features \hat{x}ᵢⱼ, with xᵢⱼ as the value of the original data set, x̅ⱼ as the feature mean, and σⱼ as the standard deviation of the related feature. After the standardization, every feature has a mean of zero and a standard deviation of one. See, Friedman, J., Hastie, T., Tibshirani, R., et al. (2001). The elements of statistical learning, volume 1. Springer series in statistics New York; and heodoridis, S. and Koutroumbas, K. (2009). Pattern Recognition. Elsevier: Burlington, San Diego, London.

For visualization purposes, the data points in the high dimensional space can, for example, be projected onto a two-dimensional subspace. In a number of studies hereof, the two-dimensional subspace is defined by the first two principal components that are fitted along the maximum variance of the data distribution. Additionally, the scree plot is provided, which indicates how much relative variance of the whole variance in the high-dimensional space is represented by the first 25 principal components. However, the principal component analysis (PCA) representation of the data points in a lower dimension can also be combined with classification methods. This becomes relevant, for example, in studies hereof with missing values.

In a number of studies hereof, the classification was performed with the kernel-based methods support vector machine (SVM) and Gaussian process classifier (GPC) as representative models. The commonly used radial basis function (rbf) kernel, also called Gaussian kernel, was applied to both of them:

$$\\ \begin{matrix}κ ( {x}_{i} , {x}_{j} ) = exp ( \frac{- {‖ {x}_{i} , {x}_{j} ‖}^{2}}{2 {σ}^{2}} ) & ( 38 )\end{matrix}$$

where xᵢ and xⱼ are two data points from which the similarity gets estimated and a is the width of the rbf kernel. In the classification process, the default hyperparameters of the algorithms from scikit-learn (an online, free software machine learning library, for example, for the Python programming language) were used and the sensitivity of the score with respect to the hyperparameters was not investigated.

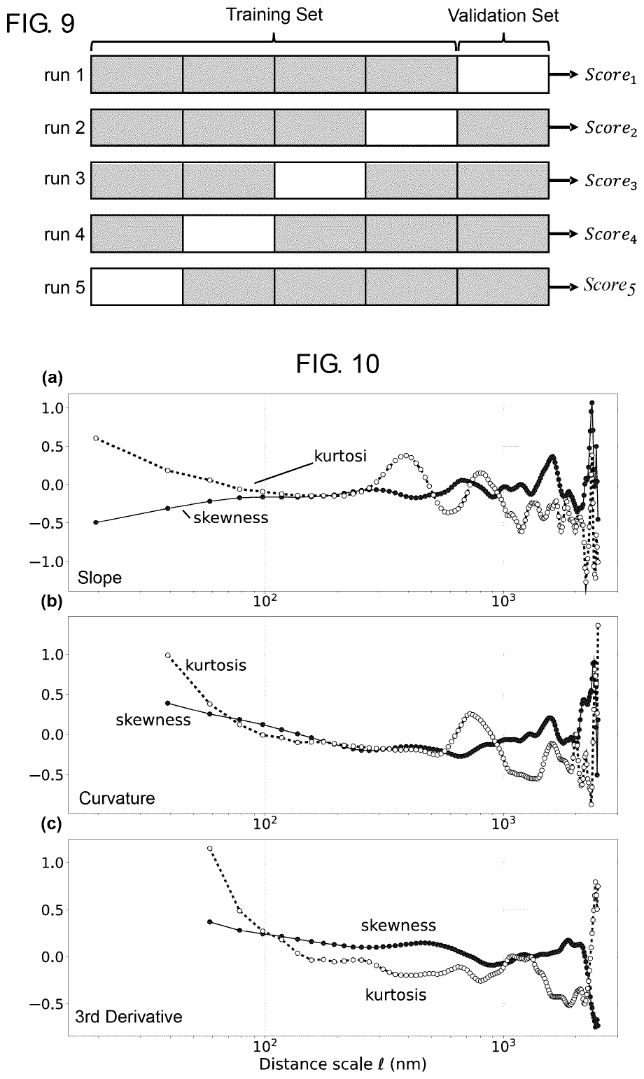

Since the classification score of a simple data split in a training and a validation set depends on the random split variable, the classification score is obtained by cross-validation. FIG. 9 shows the case of 5-fold cross validation, where the data set is split into five equal bunches. One of those bunches is used as the validation set and the other ones as the training set. The folds get varied, so that every fold is the validation set once. By doing so, a score of how many percent of the validation set was correctly predicted is returned for each train-validation configuration (fold). The cross-validation score is calculated by averaging over the scores of the folds. Additionally, the variance of the folds is obtained. See Murphy, K. P. (2012). Machine learning: a probabilistic perspective, MIT press.

A special case of the cross-validation is the “leave one out” configuration, where the validation set is just a single data point, and it is decomposed in N-folds for N data points. This approach is reasonable for very small data sets and was applied in studies 4 and 5 described below.

In the classification studies hereof, two different methods were used to estimate the feature relevance, which were PCA and the Recursive Feature Elimination (RFE). In PCA, the principal components are a linear combination of the features and weights. The larger is a weight, the more important is a feature estimated by PCA. The evaluated weights are from the principal component that separates the classes best in the PCA plot. This is usually the first principal component. In addition to or as an alternative to PCA, an autoencoder analysis may be used.

In addition to PCA, the RFE, also called backward selection algorithm, was applied in studies hereof. RFE uses a classifier for the feature evaluation. In doing so, it takes all features and removes iteratively the feature that has the least impact on the classification fit. This procedure is repeated until one feature is left, such that a ranking of features is achieved. See Friedmen et al., supra. As the classification model, the SVM was applied for the feature evaluation with RFE.

Maximizing the variance of the overall data distribution in PCA includes solving for the principal components, sorted by the amount of projected variance. This can be efficiently solved by an eigenvalue decomposition of the data covariance matrix. But in the case of missing values in the data set, the covariance matrix will also contain missing values, which makes an eigenvalue decomposition mathematically intractable. A commonly used method to handle missing values in machine learning, is to apply imputation methods. Imputation methods replace the missing values with information of other data points like for example the feature mean. In the context of multiscale features of surface topographies, imputation methods may not be very reliable. For example, if features are only accessed from measurements at the scale of meters, an estimation from other feature vectors for features at the scales of nanometers might be misleading. Rather, the intersected scales may be considered while the others are ignored. Accordingly, an adjusted PCA algorithm was implemented in a number of studies hereof that handles missing values by ignoring them during the fit.

Equivalently to maximizing the data variance, the squared error can be minimized between the data points yⱼ∈ [symbol] ^{D} and their projected representations ŷⱼ. The projected representations can be defined in the principal subspace by

ŷⱼ=Wxⱼ+m. (39)

The matrix W∈ [symbol] ^{Dx} is the set of K principal components, xⱼ∈ [symbol] ^{K} is the data point representation in the principal subspace, and the bias vector m∈ [symbol] ^{D} indicates the difference between the origin of the coordinates in the feature representation and the principal component representation.

The squared error minimization is given by the difference between the original data points yⱼ and the projected data points ŷⱼ. Thus, minimizing

$$\\ \begin{matrix}{\sum }_{j = 1}^{N} {‖ {y}_{j} - {Wx}_{j} - m ‖}^{2} & ( 40 )\end{matrix}$$

can either be transformed, or it can be solved iteratively by updating W and X=[x₁ x₂ . . . x_{N}] alternative. Bishop, C. M. (2006). Pattern Recognition and Machine Learning. Springer: New York; and Grung, B. and Manne, R. (1998). Missing values in principal component analysis, Chemometrics and Intelligent Laboratory Systems, 42(1-2):125-139. Setting the partial derivative of the minimization function with respect to W and xⱼ equal to zero, leads to the updating equations of,

X=(W^{T}W)⁻¹W^{T}Y, (41)

W=YX^{T}(XX^{T})⁻¹. (42)

The matrix Y=[y₁ y₂ . . . y_{N}] contains all data points, and the matrices X and W can be obtained by fixing one matrix and updating the other one, so that a PCA solution can be found iteratively.

The approach with alternately updating X and W can be adapted to handle missing values in the data set. Ilin, A. and Raiko, T. (2010). Practical approaches to principal component analysis in the presence of missing values. The Journal of Machine Learning Research, 11:1957-2000. In the case without missing values, the features were assumed to be zero-mean, so that the bias term m can be omitted. Due to the missing values in the data set, the features in Y cannot be trivially set to zero mean and the bias term m needs to be maintained in the alternating algorithm. Accordingly, the partial derivative of the minimization statement in Eq. 40 with respect to m is also taken into account. Additionally, the multiplication of the matrices and vectors are decomposed into sums, so that the actual sum is only taken over the indices i and j for which the data entry yᵢⱼ is observed. The updating equations are defined by

$$\\ \begin{matrix}{x}_{j} = {( {\sum }_{i ∈ {O}_{j}}^{D} {w}_{i}^{T} {w}_{i} )}^{- 1} {\sum }_{i ∈ {O}_{j}}^{D} {w}_{i} ( {y}_{ij} - {m}_{i} ) , for all j = 1 , … , N , & ( 43 )\end{matrix}$$

$$\\ \begin{matrix}{m}_{i} = \frac{1}{\vert {O}_{i} \vert} {\sum }_{j ∈ {O}_{i}} ( {y}_{ij} - {w}_{i} {x}_{j} ) , for all i = 1 , … , D , & ( 44 )\end{matrix}$$

$$\\ \begin{matrix}{w}_{i}^{T} = {( {\sum }_{j ∈ {O}_{i}}^{N} {x}_{j} {x}_{j}^{T} )}^{- 1} {\sum }_{j ∈ {O}_{i}}^{N} {x}_{j} ( {y}_{ij} - {m}_{i} ) , for all i = 1 , … , D , & ( 45 )\end{matrix}$$

with Oⱼ being the set of indices i for which yᵢⱼ is observed and with Oᵢ being the set of the set of indices j and for which yᵢⱼ is observed. The term |Oᵢ| is the size of the set Oᵢ.

Towards the goal to classify surfaces topographies, which are characterized by multiple measurements over different scales including missing values in the feature vector representation, five studies were conducted. The first study was performed with synthetic surfaces with two classes of different Hurst exponents to verify if the concept of classification is applicable. In the second study, it is determined if experimental surfaces can be distinguished from synthetic ones with a similar power spectral density (PSD). The classification between four different diamond crystalline coatings was tested in a third study. Classification of the diamond coatings of the third study, but with feature vectors extracted from multiple measurements obtained by different measuring techniques over different scales, was tested in the fourth study. In the fifth study, whether a classification can still be performed when some features in a feature vector were not observed (missing data) was tested.

The feature vectors were constructed by the scale-dependent parameters here of (SDRP and SDSPs, a generalization of scale-dependent roughness parameters or SDRPs) as described above. As discussed above, the SDSPs describe the distribution of the scale dependent derivative in more detail.

The SDRPs are considering the square-root of the second moment of the underlying distribution function of the distance scale. As described above, the underlying distribution function or scale-dependent distribution may be obtained by shifting the stencil of a finite difference approximation over a measurement profile. Thus, the distribution depends on the derivative approximations and the distance scale [symbol] =αηΔx. In the context of the scale-dependent roughness parameters, the variance of the scale-dependent distribution is examined. For a Gaussian distributed surface, the variance describes the scale-dependent probability distribution completely, but not all natural surfaces follow a Gaussian distribution (see, for example, FIG. 1, panel (b)). To explore more information about the scale-dependent distribution, the third and fourth moments may also be considered in terms of the metrics skewness and kurtosis defined above.

Moreover, the scale-dependent distribution is characterized by the scalar parameters of, for example, variance, skewness, and kurtosis in the studies hereof. As described above, the scalar parameters of skewness and kurtosis are sometimes referred to herein as scale-dependent statistical parameters or SDSP. The scale-dependent statistical parameters can, for example, be obtained of the slope, curvature, and 3^{rd} (or higher) derivative over the scale-factor η, or rather the distance scale [symbol] . The functions of skewness and kurtosis are plotted in FIG. 10, where the functions of the variance are equivalent to the functions of SDRPs. As also described above, each of the SDRP and SDSP are statistical characterization of slope, curvature, and 3^{rd} (or a higher) derivative and are sometimes referred to herein as statistically-characterized, scale-dependent parameters or simply scale-dependent parameters. Once again, such scale-dependent parameters are determined by a statistical characterization of a distribution of at least one of a first-order or higher-order derivative of surface height or h. [Revise for redundancy]

In the machine learning/classification studies hereof, there were different features sets applied, which represent the same topographies. Up to six different feature sets were investigated in the classification studies hereof including: the standardized and not standardized versions of (i) height, slope, curvature and third derivative, (ii) slope, curvature, and 3^{rd} derivative, and (iii) curvature and 3^{rd} derivative. The reason for excluding the features of the height in some experiments is due to the relation to the features of the slope. Further, the experimental topographies are tilt-corrected, which might lead to artefacts in the features of the height and slope. The tilt in the measurements appears as a result of tilts of the measuring devices. The tilt is removed or corrected by fitting a midline to the topography and setting the slope to zero. Since the effect of the tilt-correction is not clear regarding the classification, the features of height and slope are omitted in some feature sets. Additionally, standardized as well as non-standardized features sets were applied, since it was not clear if it is better for the classification to have a uniform unit or to maintain the original units to take advantage of their geometrical meanings.

For each study, the data was projected onto two dimensions by the principal component analysis (PCA) to better understand the data distribution. Moreover, the data was classified by cross-validation with the machine learning methods support vector machine (SVM) and the Gaussian process classifier (GPC). Additionally, the features were investigated with the recursive feature elimination (RFE) method and the PCA to determine which features are more relevant for the classification.

Study 1. Synthetic Surfaces

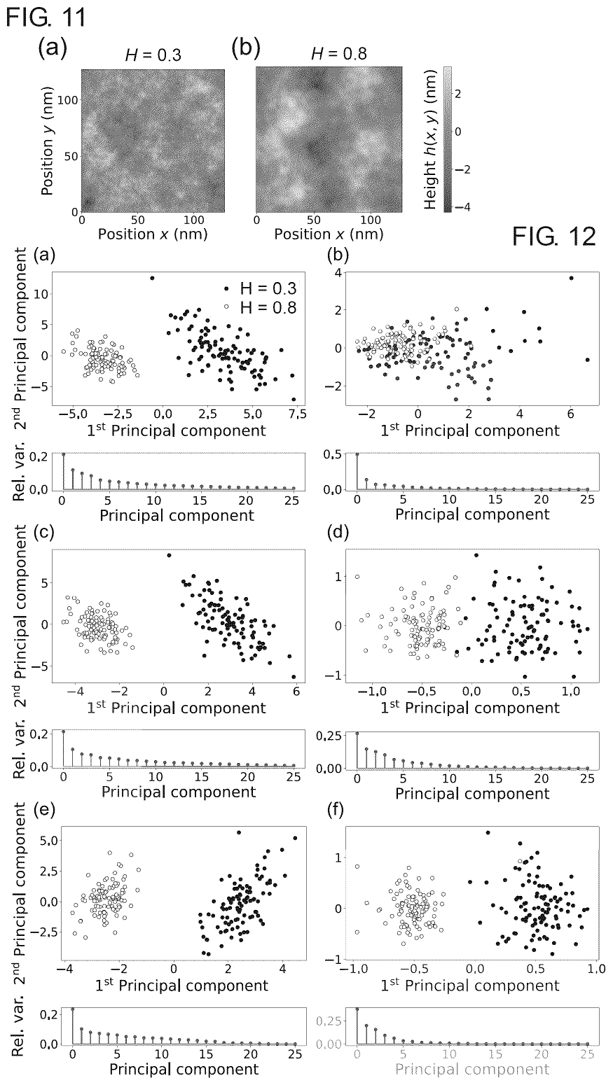

In this study, synthetic surfaces were generated with the same input parameters except the Hurst exponent H. 100 surfaces were generated with H=0.8 and 100 other surfaces were generated with H=0.3 as represented by the images in FIG. 11. Each surface had a size of 128×128 nanometer and a resolution of one nanometer. The distance scales [symbol] =ΔηΔx where the scale-dependent parameters were obtained were 1, 4, 10, 25, 50, and 100 nm for the height and slope features, 2, 8, 20, 50, and 100 nm for the curvature features, and 3, 12, 30, and 75 nm for the features of the 3^{rd} derivative.

The PCA plots in FIG. 12 show the data distribution projected onto the two axes with the largest variance. The plots with the standardized features, show that the surface classes are separated and have no overlap in the two-dimensional subspace.

According to the scree plot, approximately 30% of the variance is shown in the plots, while approximately 70% are still hidden. The data set with the non-standardized features are not separated as well as the classes in the plots of the standardized features. However, the classes in panel (d), without the height features, are visually better distinguishable than those with all features in panel (b). A plot of just the curvature and 3^{rd} derivative features in panel (f) provide a better separation compared to the plots of panels (b) and (d). The plots in panels (b) and (f) show approximately 60% of the overall data variance, while in panel (d), approximately 40% of the variance is maintained.

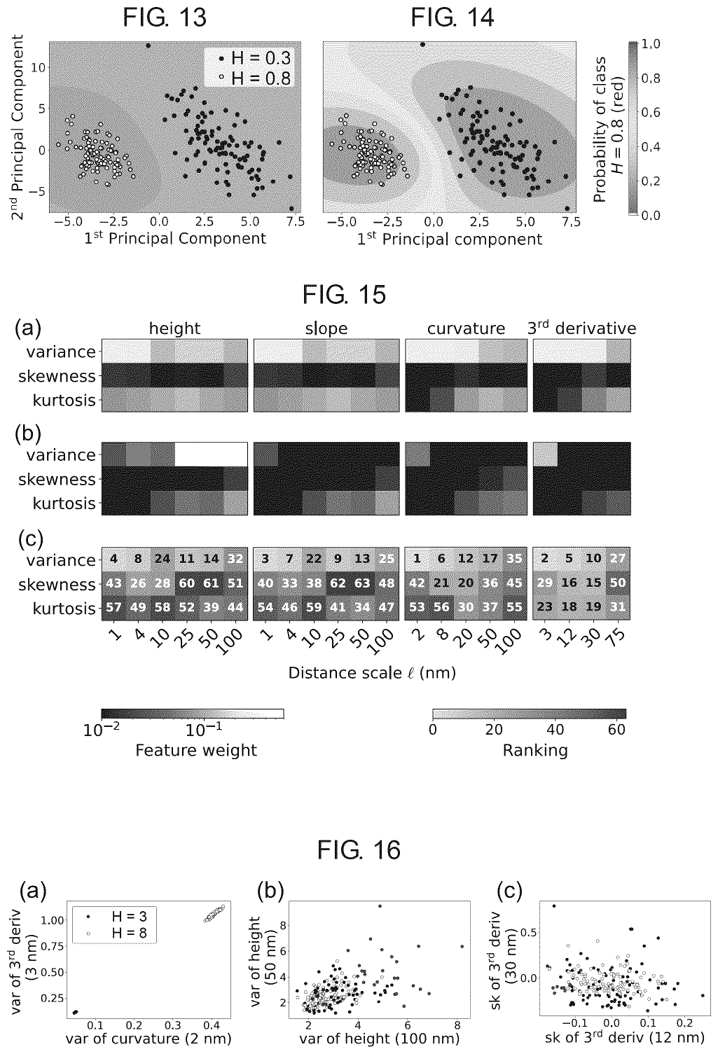

Table 1 shows the classification results of both the support vector machine (SVM) and the Gaussian process classifier (GPC) with the radial basis function (rbf) kernel. The classification score was obtained by 5-fold cross validation. All classifications have a score of 1.0 except the non-standardized features of height, slope, curvature and 3^{rd} derivative, classified by the GPC, which have a slightly lower score of 0.99. Additionally, FIGS. 13 and 14 show the visual classification areas of the SVM and GPC, respectively, trained in the two-dimensional PCA subspace. The SVM in FIG. 13 has a solid border between the classes, while the GPC in FIG. 14 provides a probability distribution for data points being part of the class.

TABLE 1
Study 1: Classification score obtained by 5-fold cross validation,
rounded to three decimal digits. SVM and GPC with rbf kernel.

| Features | Standardized | Not Standardized |
|---|---|---|
| Height, Slope, Curvature, 3^{rd} Derivative | SVM: 1.000 ± 0.000 | SVM: 1.000 ± 0.000 |
| | GPC: 1.000 ± 0.000 | GPC: 0.990 ± 0.000 |
| Slope, Curvature, 3^{rd} Derivative | SVM: 1.000 ± 0.000 | SVM: 1.000 ± 0.000 |
| | GPC: 1.000 ± 0.000 | GPC: 1.000 ± 0.000 |
| Curvature, 3^{rd} Derivative | SVM: 1.000 ± 0.000 | SVM: 1.000 ± 0.000 |
| | GPC: 1.000 ± 0.000 | GPC: 1.000 ± 0.000 |

FIG. 15 shows the individual feature weights of the first principal component, related to the feature set including features of height, slope, curvature, and 3^{rd} derivative. The relevance estimations of the other feature sets (with and without height and slope) are qualitatively the same. Some differences between the standardized features of panel (a) and the non-standardized features panel (b) are observable. For the standardized features, the values of the variances have a higher relevance for the height, slope, curvature, and 3^{rd} derivative, and the features belonging to distance scales closer to the resolution have a higher relevance than those belonging to the larger distance scales. The skewness parameters are estimated to be less relevant than the parameters of kurtosis. Additionally, the feature estimation of the height and slope are equal with respect to the same feature-type (variance, skewness, and kurtosis) and same distance scale. For the non-standardized features, the variance of the height at the distance scales of 25, 50, and 100 nanometer have a very high estimated relevance. Additionally, some single features of the slope, curvature, and 3^{rd} derivative have more estimated relevance than most of the remaining features. The evaluation with the recursive feature elimination (RFE) in panel (c) of FIG. 15 rates features of the variance higher than features of the skewness and kurtosis. According to panel (a), the best features are determined at the small distance scales (1-30 nm) for all derivatives (including height as 0-th derivative).

According to the PCA feature evaluation of the standardized data set and the RFE estimation, the two best-evaluated features by the RFE are plotted in FIG. 16 panel (a). The classes are clearly separable and the even one of the features in panel (a) suffices to separate the classes by a straight line. Additionally, the features show a high correlation since the data points are roughly aligned along the diagonal axis of the plot. The features of variance in panel (b) are the best-rated features from the non-standardized data set as determined by PCA, but the classes are not visually distinguishable by a straight line. A similar setting of non-separable classes is illustrates in panel (c), where the best-rated non-variance features as determined by the RFE are plotted. Additionally, the center of the cluster is approximately at zero for both axes.

Study 2. Experimental and Synthetic Surfaces with Same PSD

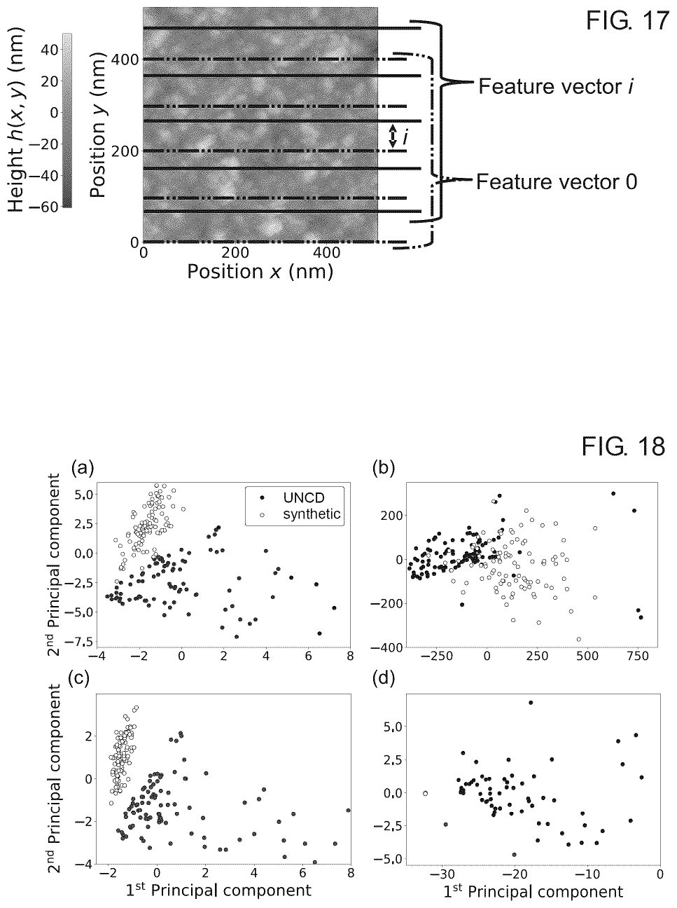

Study 2 included analysis of an ultrananocrystalline diamond (UNCD) coating measured by an atomic force microscope (AFM) of the size 2 500×2 500 nanometer with a resolution of 4.88 nanometer. From the surface topography, the power spectral density (PSD) was extracted and synthetic surfaces were generated using the PSD as the variance of the amplitudes of the Fourier coefficients. Thus, 100 synthetic surfaces with the same size and resolution as the UNCD surface were generated. From each surface, a feature vector was obtained. Further, 100 data points were generated from the experimental UNCD surface. FIG. 17 illustrates the process of generating the data points of the two-dimensional UNCD surface. The surface was split into 100 equal bunches of five measurement profiles each, and a feature vector was then generated by a single bunch of profiles. The five profiles were uniformly spread over the two-dimensional area with the measurement profiles of the i-th feature vector for i between zero and 99. The set of distance scales for the features used in this experiment is 4.88, 48.8, 240, 480, 878.4, 1 464, and 2 196 nm for the height and slope, 9.76, 97.6, 480, 960, and 1 756.8 nm for the curvature, and 14.64, 146.4, 720, and 1 440 nm for the 3^{rd} derivative.

FIG. 18 shows the PCA plots related to this study. The configuration of the slope, curvature, and 3^{rd} derivative features is omitted here because, (i) in the standardized setting, it is similar to panel (a), and, (ii) in the non-standardized setting, it is comparable to panel (d). The PCA plots of the standardized data in panel (a) and panel (c) of FIG. 18 look quite similar, except that the classes in panel (c) can be separated by a straight line. There is a slight overlap in panel (a). For the non-standardized data, in panel (b) the axes range is two orders of magnitude higher than the axis range for the other plots, and the data points of the classes have some intersection. In contrast, in panel (d), the classes are very well separated. Additionally, the class of the UNCD data points is much more spread than the class of the synthetic surfaces.

The classification scores in Table 2 indicate a score of 1.0 for the SVM and GPC for all standardized feature sets. For the non-standardized feature sets, the SVM has a score of 0.9 or slightly higher. The GPC classifies the feature set without the height better than the SVM with a score of 1.0. In contrast, the classification score including the height features is relatively low at 0.510.

TABLE 2
Study 2: Classification score obtained by 5-fold cross validation,
rounded by three decimal digits. SVM and GPC with rbf kernel.

| Features | Standardized | Not Standardized |
|---|---|---|
| Height, Slope, Curvature, 3^{rd} Derivative | SVM: 1.000 ± 0.000 | SVM: 0.905 ± 0.002 |
| | GPC: 1.000 ± 0.000 | GPC: 0.510 ± 0.001 |
| Slope, Curvature, 3^{rd} Derivative | SVM: 1.000 ± 0.000 | SVM: 0.900 ± 0.002 |
| | GPC: 1.000 ± 0.000 | GPC: 1.000 ± 0.000 |
| Curvature, 3^{rd} Derivative | SVM: 1.000 ± 0.000 | SVM: 0.905 ± 0.002 |
| | GPC: 1.000 ± 0.000 | GPC: 1.000 ± 0.000 |

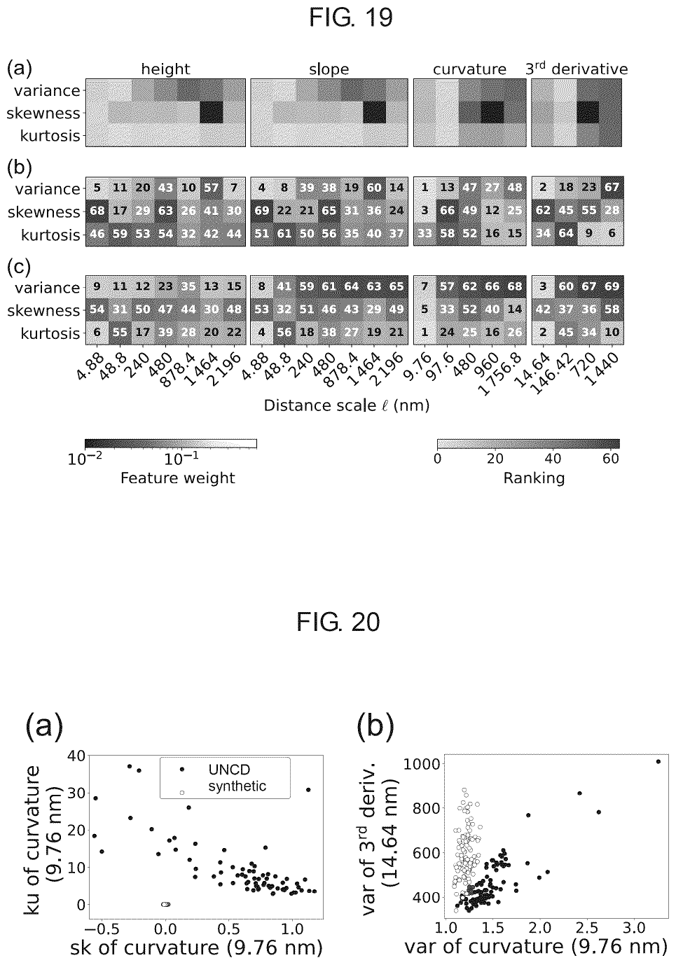

FIG. 19 panel (a) shows the estimated feature relevance of the first principal component for the standardized features. As in the first study, the estimation with a smaller standardized feature set is qualitatively the same as for non-standardized data. The variance features of the height are rated very highly similar to the results in FIG. 15 panel (b). The estimation of the height and the slope is equivalent, and the features of kurtosis have generally the highest estimated relevance. The features of the variance exhibit a high estimation for small distance scales and a low estimation for higher. Like the PCA feature estimation, the RFE generally rates features at low distance scales as more relevant for the classification. The best three rated features by the RFE are part of the curvature and 3^{rd} derivative features. This applies for the standardized (panel (b)) and non-standardized (panel (c)) feature sets in FIG. 19. Additionally, some of the overall best rated features in panel (c) are of kurtosis. FIG. 20 panel (a) shows how the data is distributed with respect to the features of skewness and kurtosis (with best ranking in FIG. 19, panel (c)). Further, the best-rated features of FIG. 19 panel (c) are set forth in FIG. 20 panel (b), which illustrates two clusters with some overlap.

Study 3. Experimental Surfaces

In this study, four different types of experimental surfaces were compared, including the microcrystalline (MCD), nanocrystalline (NCD), ultrananocrystalline (UNCD), and polished ultrananocrystalline (PUNCD) diamond coatings described in Gujrati, A., Sanner, A., Khanal, S. R., Moldovan, N., Zeng, H., Pastewka, L., and Jacobs, T. D. (2021). Comprehensive topography characterization of poly-crystalline diamond coatings. Surface Topography: Metrology and Properties, 9(1):014003. In total, there were four 2D measurements of each coating type (16 surfaces in sum) applied to generate the data points for the classification. The surfaces were measured by an atomic force microscope and have the size of 2,500×2,500 nanometer by a resolution of 4.88 nanometer. For each class, 100 data points were extracted, so that 25 data points were obtained from each 2D measurement. The process to generate multiple feature vectors from one 2D surface is illustrated in FIG. 17. In contrast to the second study, there are 20 one-dimensional profiles used to build a feature vector instead of five. The distance scales for the features, applied in this experiment are 4.88, 48.8, 240, 480, 878.4, 1 464, and 2 196 nm for the height and slope, 9.76, 97.6, 480, 960, and 1 756.8 nm for the curvature, and 14.64, 146.4, 720, and 1 440 nm for the 3^{rd} derivative.

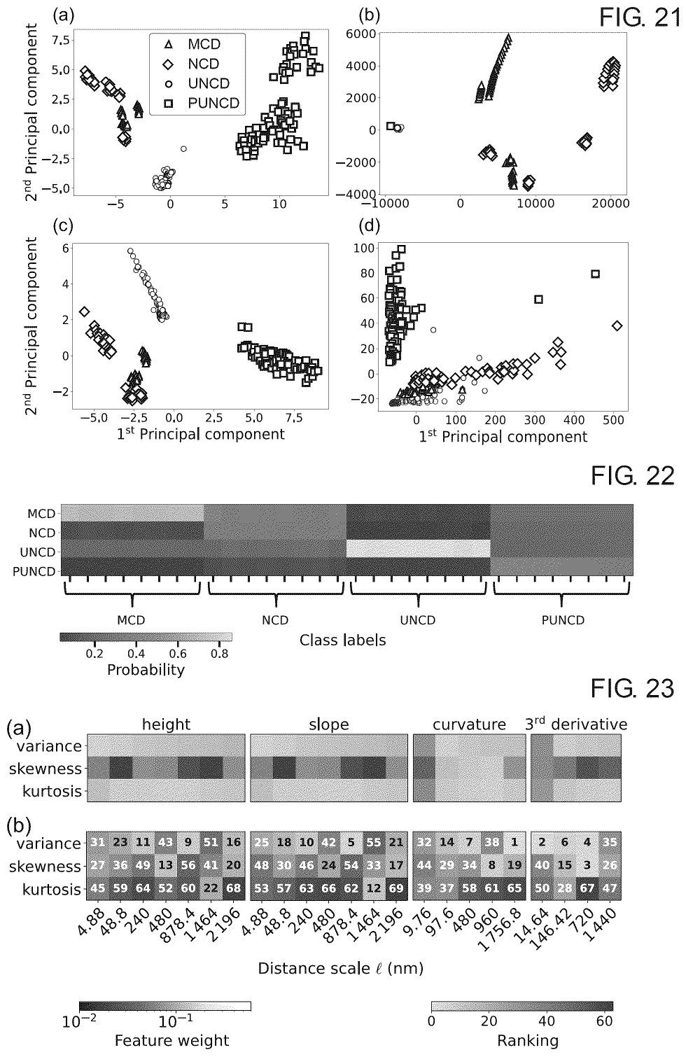

In addition to the classification with cross validation performed in the other studies, a classification with a certain split in training set and validation set was performed in this study. In that regard, the 25 obtained feature vectors of the same 2D measurement formed sub-clusters, especially for the MCD and UNCD surfaces (see FIG. 21). To verify that a feature vector sampled from a measurement that was not used for training can be classified correctly, the data points of three surfaces of each class were assigned to the training set, and the data points of the remaining surfaces were assigned to the validation set.

FIG. 21 shows the PCA plots of the MCD, NCD, UNCD, and PUNCD sample points. The classes of UNCD and PUNCD build one cluster each, while the MCD and NCD labels form three to four clusters each in the plots of panels (a), (b), and (c). Those plots show a clear separation between the clusters other than some overlap of the MCD and NCD classes in panel (c). In contrast, the classes in panel (d) exhibit only one cluster each, and are qualitatively closer together, especially for the MCD, NCD, and UNCD classes. Additionally, in panel (b) the clusters of UNCD and PUNCD are more compact compared to the MCD and NCD clusters, and the axes in panel (b) are two or three magnitudes higher than the other panels.

The classification scores of the 5-fold cross-validation are listed in Table 3. The score of the standardized data is almost 1.0 for all listed cases. The non-standardized data sets have a lower classification score, but the feature sets without the height features still exhibit a good classification score of around 0.9. However, the performance of the non-standardized feature set of the height, slope, curvature, and 3^{rd} derivative features is 0.628 for the SVM, and 0.71 for the GPC, which is significantly worse, but still better than the score of a random guess of 0.25. Additionally, the GPC has a classification variance of 0.126, while it is close to zero for the other cases. These results indicate that the classification score may depend strongly on the train-validation split of the data set.

TABLE 3
Study 3: Classification score obtained by 5-fold cross validation,
rounded by three decimal digits. SVM and GPC with rbf kernel.

| Features | Standardized | Not Standardized |
|---|---|---|
| Height, Slope, Curvature, 3^{rd} Derivative | SVM: 0.997 ± 0.000 | SVM: 0.628 ± 0.002 |
| | GPC: 1.000 ± 0.000 | GPC: 0.710 ± 0.126 |
| Slope, Curvature, 3^{rd} Derivative | SVM: 0.997 ± 0.000 | SVM: 0.913 ± 0.001 |
| | GPC: 1.000 ± 0.000 | GPC: 0.913 ± 0.001 |
| Curvature, 3^{rd} Derivative | SVM: 1.000 ± 0.000 | SVM: 0.895 ± 0.002 |
| | GPC: 1.000 ± 0.000 | GPC: 0.905 ± 0.001 |

In comparing the training principles of the different classifier, a visualization was created of the trained models of the SVM and GPC in the PCA subspace of the first two principal components for the standardized data set with all features. For the training, all available data points were applied. In the visualization, the GPC trained very well, even in the two dimensional space, while the MCD classification area of the SVM overlapped with some NCD data points.

The classification with the single split into a training and a validation set regarding four surface measurements of each class with the standardized feature set of height, slope, curvature, and 3^{rd} derivative resulted with a score of 0.93 for the SVM and 0.84 for the GPC. The GPC did not return only a predicted class label as is the case with the SVM, but provided a probability for each predicted data point to be part of all trained classes. These probabilities are shown for some predicted data points in FIG. 22. The MCD and UNCD surfaces can be classified quite certainly with a probability of approximately 60% and 80%. Also, the sample points of the PUNCD class have the highest probability for the correct label and are therefore classified correctly. Only the sample points of the NCD surface did not have a significantly higher probability. They were misclassified in 16 of 25 cases. However, the probabilities of the MCD and NCD classes are significantly higher than of the UNCD and PUNCD ones.

FIG. 23 shows that the PCA estimated by the features of the skewness were worse than the ones of variance and kurtosis, while the RFE rates features of the variance higher. There was a significant contradiction in the estimation of a 3^{rd} derivative skewness feature at 720 nm. In that regard, RFE rated it very high, while the PCA rates it low. Furthermore, the RFE estimated features of the curvature and 3^{rd} derivative higher than those of the height and slope, while the PCA rated the curvature features higher than the other derivatives.

Study 4. Combining Measurements over Multiple Scales

Similar to study 3, the experimental surfaces of MCD, NCD, UNCD, and PUNCD were analyzed in study 4. Unlike the third study, however, AFM scans of the same size were not used. Rather, multiple measurements of the same surface were combined in a feature vector. Each feature vector represented ten different measurements in order to span over the scales from nanometers to millimeters. The range of scales spanned by individual measurements partially overlap, so that the scale-dependent parameters/SDSPs at a given distance scale are obtained by averaging the scale-dependent parameters/SDSPs of the measurements that cover the scale. The measurements were obtained by three different measuring techniques (stylus profilometer, AFM, and transmission electron microscopy (TEM)). In total, 30 feature vectors were generated (6 of MCD, 6 of NCD, 12 of UNCD, and 6 of PUNCD). The features of slope, curvature, and 3^{rd} derivative all covered the distance scales of 1, 5, 10, 100, 500, 1 000, 5 000, 10 000, 50 000, 100 000, and 500 000 nm.

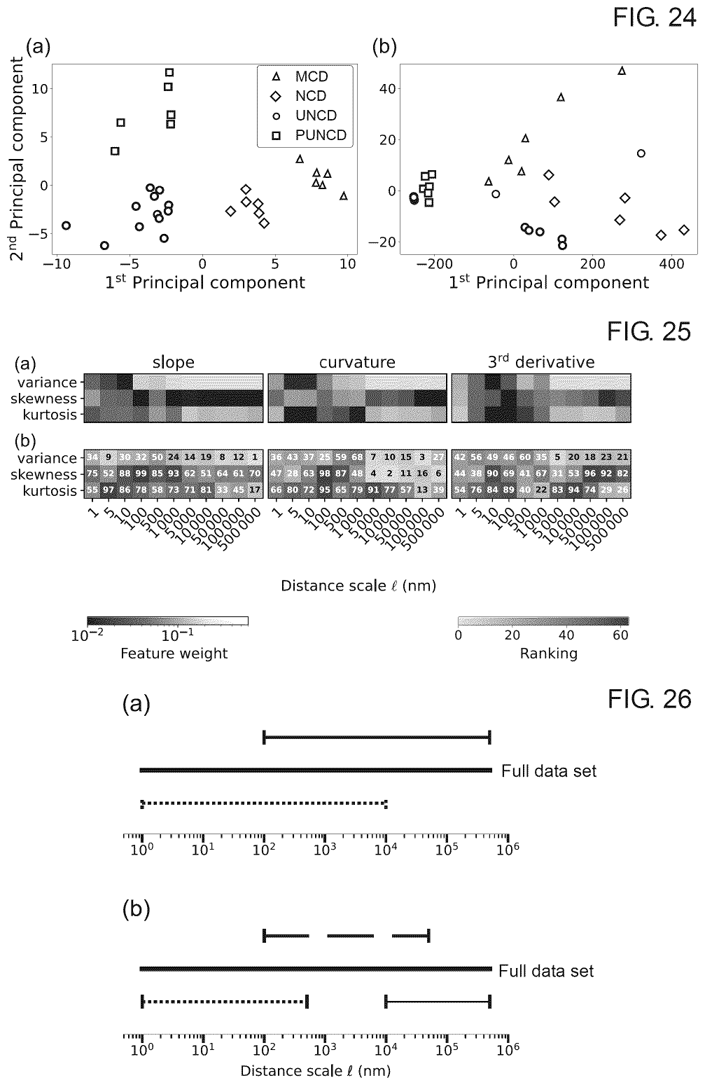

FIG. 24 illustrates the PCA plots of the feature sets including all features. The PCA plots of the features set with just curvature and 3^{rd} derivative features are very similar. For the standardized features set of panel (a), the classes were clearly separable. In the non-standardized features set of panel (b), the classes are more intermixed. Only the PUNCD class clusters clearly in the non-standardized features. The MCD and NCD data points are somewhat widespread, while the data points of the UNCD surface, are even more significantly spread over the PCA subspace.

Because of the small amount of data points, the classification score was obtained by leave-one-out cross-validation as described above. The related classification scores are shown in Table 4. The score of the standardized data with the SVM is quite good (close to 1.0), while the GPC performs a bit worse with a score of 0.867 for the larger feature set. For the smaller features set (with only curvature and 3^{rd} derivative features), the GPC performed worse. Additionally, the variance of the GPC scores approached 0.2, which is quite high. The score of a single classification task depends strongly on the train-validation split. The classification score of the non-standardized data is relatively poor for both classifiers (0.333 and lower).

TABLE 4
Study 4: Classification score obtained by leave-one-out cross validation,
rounded by three decimal digits. SVM and GPC with rbf kernel.

| Features | Standardized | Not Standardized |
|---|---|---|
| Slope, Curvature, 3^{rd} Derivative | SVM: 0.967 ± 0.032 | SVM: 0.333 ± 0.222 |
| | GPC: 0.867 ± 0.116 | GPC: 0.200 ± 0.160 |
| Curvature, 3^{rd} Derivative | SVM: 0.967 ± 0.032 | SVM: 0.333 ± 0.222 |
| | GPC: 0.733 ± 0.196 | GPC: 0.333 ± 0.222 |

The feature estimations of PCA and RFE are set forth in FIG. 25. Both estimate a higher relevance for features at distance scales larger or equal to 5000 nm. The PCA rates the features of variance very high, while the RFE shows high-rated features of variance for all derivatives and high-rated skewness features of the curvature. The low rating of PCA for skewness features of the curvatures does not coincide with the rating of the RFE.

Study 5. Processing with Incomplete Feature Vectors

In study 5, the data set from the fourth study with the slope, curvature, and 3^{rd} derivative features was used. To simulate the situation in which not all measurements were made over the same scales, some values were removed from the data set in study 4. By doing so, the set of features that are obtained at a certain distance scales was removed. That set included variance, skewness, and kurtosis for all derivatives. Because it was observed in the fourth study that the standardized features performed better than the non-standardized features, standardized features were used in this study. For the standardization, the mean and standard deviation of each feature needed to be calculated. In doing so with missing values, the mean and standard deviation were calculated only over the observed values, while the missing values were ignored.

Because standard classification algorithms cannot readily handle missing values in the data set, a PCA method was implemented which handles such missing values. Preprocessing the data set with missing values by the modified PCA method led to a data point representation in the PCA subspace that did not contain missing values. In order to evaluate the performance with missing values, 25%, 40%, 60%, and 75% of all values were removed.

The phrases “missing data points” or “missing values” refers to values absent or missing in the feature vector \vec{f}. For example, one may use the scale-dependent parameters hereof at distances 1 nm, 1 um and 1 mm, giving us a feature vector \vec{f}=(f₁, f₂, f₃). Not all instruments may measure all scales, such that f₁ may be missing. Such a situation is simulated by removal of data as described above in this study.

One may map the feature vector onto a reduced vector \vec{g}=F(\ddot{f}) where \vec{g} now has a shorter length, e.g. \vec{g}=(g₁, g₂). This approach is called dimensional reduction. The simplest incarnation for the above example would be to discard missing values from the feature vector. In a representative example of a more rigorous approach, one may use a linear or nonlinear principal component analysis (PCA) to reduce the dimensionality. Linear PCA uses the mapping \vec{f}=W\vec{g}+\vec{m} where W is a matrix that contains the so-called principal components. W can be determined if \vec{f} has missing data points. Such an algorithm is described, for example, in Ilin, A. and Raiko, T., Practical approaches to principal component analysis in the presence of missing values, The Journal of Machine Learning Research, 11:1957-2000 (2010).

Two different feature sets with 25% missing values were constructed. Features of large distance scales (100-500,000 nm) were removed from one features set, while features of smaller distance scales (1-1,000 nm) were removed from the other set as illustrated in FIG. 26 panel (a). Removing the features of a certain length scale included the features of the variance, skewness, and kurtosis of the slope, curvature, and 3^{rd} derivative. In that regard, all those features are not observed when a distance scale is not covered by a measurement. Those feature vectors which were affected by the removal were chosen randomly. The configuration of 40% missing values was created by removing sets of features from large (1,000-500,000 nm) and small (1-500 nm) distance scales independently (represented by right and left dashed line bandwidths in FIG. 26 panel (b)). Thus, both scale sections, just one scale section, or no scale section can be removed from a feature vector. The same procedure was applied in the cases with 60% and 75% missing values, where, additionally, the distance scale from 100 to 50 000 nm (solid line bandwidth in FIG. 26 panel (b)) was removed of some feature vectors. To keep some information about the underlying surface, in no studies were all three scale sections removed of one feature vector.

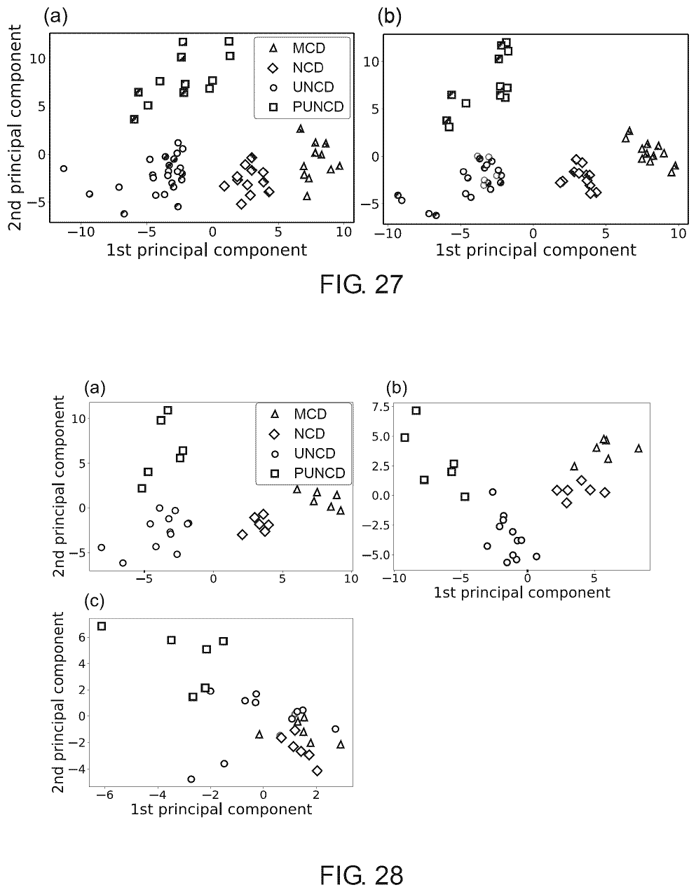

FIG. 27 shows, in panel (a) and panel (b) thereof, the missing-value PCA in which 25% of the values are missing, including the PCA data point representation of the complete feature vectors, marked by the black edges. The incomplete feature vectors still cluster in the same classes. Moreover, the PCA data points are close to the ones of the complete feature vectors. Additionally, the other configurations with missing values are illustrated as PCA plots in FIG. 28. As seen in FIG. 28, the cases with 40% and 60% (panels (a) and (b), respectively) still cluster in the correct classes, but they are closer to each other than with 25% missing values. The MCD and NCD classes in panel (b) are especially very close as well as the UNCD and PUNCD classes in panels (a) and (b) of FIG. 28. With 75% missing values in panel (c) of FIG. 28, the clusters overlap at many points.

The classification was performed by leave-one-out cross-validation and the scores are shown in Table 5. The two configurations of 25% missing values (with removing the large and the small distance scales) have the same classification score given in the table. In general, the SVM classifies very well for 25%, 40%, and 60% missing values, exhibiting a score of or close to 1.0. However, the GPC classifies, for the same cases, with approximately 0.75 and exhibits significant variance in the classification (almost 0.2). The case with 75% missing values exhibited a relatively low classification score for both classifiers with a significant classification variance. In contrast to the other cases however, the GPC has a better score than the SVM for the case with 75% missing values.

TABLE 5
Experiment 5: Classification score with leave one out cross validation,
rounded by three decimal digits. SVM and GPC with rbf kernel.

| Classifier | 25% | 40% | 60% | 75% |
|---|---|---|---|---|
| SVM | 1.000 ± 0.000 | 0.967 ± 0.032 | 0.967 ± 0.032 | 0.433 ± 0.246 |
| GPC | 0.767 ± 0.179 | 0.767 ± 0.179 | 0.733 ± 0.196 | 0.567 ± 0.246 |

Summarizing the results of studies 1 through 5, the first through the fourth studies demonstrated that a successful classification score of 1.0 or slightly lower was achieved for at least one data set configuration with one of the classifiers SVM or GPC. The same applies to study 5 with up to 60% missing values. Compared to the GPC, the SVM showed a slightly better classification performance than the GPC in studies 4 and 5. The high classification variance in the different train-validation splits of cross-validation, showed that the GPC predictions were not very reliable in that context. This classification variance might be decreased for a larger data set. In contrast to the SVM, the GPC provides a prediction probability for each class label. Referring to the third experiment, there was a very good score result of the feature set in FIG. 21 panel (a) achieved by applying cross-validation, but the model based upon this data, might perform worse for new data since the data points (or sub-cluster) of MCD and NCD are closely aligned to each other in the PCA plot. Similar to study 3, assigning the data points of one measured surface of each class as a validation set (for each class, 100 data points were extracted out of four different measurement surfaces), leads to a more difficult classification task. In this context, the SVM performs slightly better as determined by the classification score, but the GPC provides a prediction probability for each validation point for each class. The result can be evaluated for the predictions as shown in FIG. 22. In FIG. 22, the validation points of MCD, UNCD, and PUNCD are predicted correctly, while the prediction errors arise only through NCD data points being predicted as MCD. Thus, the GPC can state with substantial certainty that a feature vector belongs to either to the MCD or NCD class. In this context, the GPC provide a better estimation than the SVM, since the SVM returns only a class label that can be either right or wrong. The same analysis applies in the context of missing values in study 5 with 75% missing values. Even when the missing information about the data distribution overcomes the classification, the probabilities provide by the GPC might provide sufficient information about the more probable class labels such that the prediction can be narrowed down to two or three classes out of four classes.

As demonstrated in study 5, handling the missing values with an algorithm such as a missing value PCA method and classifying the data in the two-dimensional subspace worked well. The amount of information about the data distribution would increase for maintaining more than two principal components. However, that methodology would increase the computational complexity significantly as a result of the matrix inversion in Eq. 43, which increases with the number of principal components. Predicting new data which occurs in the high-dimensional space and are not transformed to the PCA subspace, can be applied to the trained model, whether it includes missing values or not. In so doing, the data can be projected onto the principal components before applying them to the trained model. For predicting data points with missing values, the projection can be performed by ignoring the missing values in the matrix multiplication.

In general, the analysis hereof is not overly sensitive to missing data points or data sets/surface scans having different or limited bandwidth (which results in values missing from the feature vector). Various length scales will be missing from the data set created by one or more scans of a subject surface as a result of bandwidth limitation of measuring instruments. Nonetheless, a subject surface can be adequately characterized via the devices, systems, and methods hereof even in the case of missing data or limited bandwidth. In a number of embodiments, a principal component analysis algorithm used herein is adapted to handle missing values of data or data sets having different/limited bandwidth. In a number of embodiments, missing data may also be imputed as known in the art.

Both classifiers used in the studies hereof were applied with the standard hyperparameters of scikit learn. Therefore, classification results may be further optimizable. There may be greater potential for optimization in the case of the classification with non-standardized features. Adjusting the classifiers may increase the score, but the adjustment should be done for each setting separately. Further improvement or optimization the classification models of the standardized features may be more difficult because the default hyperparameters fitted well, and prepossessing the features by standardization worked successfully.

The classification results in the studies include the score of various combinations of feature sets. Additionally, the features are evaluated by the weight according the PCA and by the RFE. The classification of the standardized features was always equal to or better than the case without standardization. The score of the standardized features was particularly better than the case without standardization in study 4. Additionally, the PCA plots of the standardized features demonstrate, in the most cases, a better visual clustering of the classes. In contrast, the PCA of non-standardized features seems to overestimate larger values than what the scree plots indicate in a number of studies (see, for example, FIG. 12). Similarly, in the feature relevance estimation in the first experiment in FIG. 15 panel (b), some features are rated very high and others very low. However, the highly rated features are not necessarily valuable features for the classification (see, for example, FIG. 16 panel (b)). Overall, the use of standardized features is recommended, since it prevents overestimation of high values and generally leads to a better classification score. Additionally, as discussed above, the standardized features better match the standard hyperparameter settings of the classifiers.

Which features of the distributions (for example, variance, skewness, kurtosis or higher-order moments/cumulants) play an important role, depends on the pool of surfaces that is classified. In study 1, the classification was mainly performed over the features of the variance as shown in FIG. 16 panel (c). In that regard, the synthetic surfaces follow a Gaussian distribution and, therefore, the skewness and kurtosis features fluctuate around zero. In contrast, some highly rated variance features are very powerful as shown in FIG. 16 panel (a) and can classify the various classes without the information of the other features. The features of skewness and kurtosis were further investigated in study 2 in which the variances of the height are similar by construction because of the related power spectral density (PSD). In that study, the ability to classify using skewness and kurtosis features is shown in FIG. 20 panel (a). Additionally, the RFE of the standardized feature set rated some features of the variance high, which are expected to be less relevant as a result of the related PSD. FIG. 20 panel (b) demonstrates that, in the case of study 2, the variance of curvature and the 3^{rd} derivatives allow one to classify the surfaces. Without limitation to any mechanism, that result may be caused by instrumental noise and tip artifacts, which occur mainly at small scales of the curvature. However, further investigations would be necessary for a conclusion.

Overall, the variance features may be more relevant in the classification context in the studies hereof, but the skewness and kurtosis features also exhibited high ratings (for example, in study 4 (see FIG. 25 panel (b)). As observed in all five studies discussed above, there is a significant variation of highly rated features. It is thus useful to maintain all such features to keep a general set of features that is also applicable to be adapted for use in specific cases.

In the representative studies hereof, the classification score was not significantly deteriorated by removing features of height and slope from the classification. These features were not very important or were at least redundant to the scale-dependent higher derivatives. Additionally, the features of height and slope are dependent since the stencil for obtaining the scale-dependent distribution of height and slope is the same except for the division of the distance scale for the slope. This observation is in agreement with the results of the first three studies in which the scores of the standardized features, with and without the height features, were always the same. Also, the feature relevance estimation of the PCA is equivalent for both cases. In contrast, the dependency of the non-standardized features were interpreted differently as a result of the overestimation of large values (which are the features of the height).

Artifacts from surface measurement produced by the unknown tilt of the measuring device, which is typically automatically corrected, can affect some slope features. In contrast, this effect is not noticeable in the features of curvature and 3^{rd} derivative. Comparing the studies conducted with and without the slope features demonstrated that there is no harmful effect of the tilt in terms of classification. To the contrary, the classification score was found to increase slightly in study 4 in which slope features were included. Nevertheless, this effect might be larger in the case of measurements obtained by other measuring devices. Further, the features of curvature and 3^{rd} derivative might compensate inexpressive features of the slope in terms of classification, since the classification relies more on features that provide information about the class separation than on those feature that do not. Overall, the results of the present studies indicate that features of the height may be excluded while the features of curvature and third derivative should be included. Including the slope features might add some information about the topography, but might also add measuring artifacts. Thus, such considerations should be assessed on a case-by-case basis.

Most portions of the available bandwidth were covered by the features in studies 1 through 5. In study 4, larger distance scales (5,000-500,000 nm) were rated more relevant than smaller distance scales (see FIG. 25). It could thus be concluded that those scales are more relevant in the context of the diamond crystalline classification of study 4. Studies 3 and 5 demonstrated that the classification is applicable not just for those large scales. In study 3, it was shown the scales from 4.88 to 2 196 nm contain enough topographical information for a classification. Whereas in study 5, some data points (25% missing values) were removed from the bandwidth from 100 to 500 000 nm, while the classification over the common bandwidth from 1 to 10 nm was still successful. Applying small scales (for example, down to the measurement resolution) might be misleading for the actual similarity of the topography because tip artifacts of the measuring devices might appear for techniques such as AFM and stylus profilometer measurements. To detect the scale where tip radius effects/artifacts become significant, a determination of tip radius effects as described herein may be used to determine a reliability cut-off. Moreover, large scales (for example, close to the measurement size) have just a few values that describe the scale-dependent distribution. Therefore, estimating the variance, skewness and kurtosis for such large values is not very reliable, and using distance scales too close to the limits of the measurement may lead to inexpressive features. Overall, the multiscale behavior of the topographies was extracted by the scale-dependent parameters hereof at two to six distance scales per decade, while the fourth and fifth studies performed well with just two distance scales per decade. Even considering just two distance scales per decade includes redundancies in context of the diamond crystalline classification. As demonstrated in study 5, removing some scales of some data points does not decrease the classification score significantly. Considering significantly fewer distance scales might not provide enough information about the topography for the analysis of other properties. Thus, for an extensive description of the topography, two or three distance scales per decade may be appropriate.

As described above, the classifications hereof were performed with the kernel-based support vector machine (SVM) and the Gaussian process classifier (GPC). Other classification models/algorithms may be used. As known in the computer and machine learning arts, classification refers to models for a class label, which is a quantity that can only take two values. Regression models/algorithms may also be used. Regression refers to models for a continuous quantity that can take any value. Given a set of “features” expressed as a vector \vec{f}, a classification model predicts/computes a class label y. A label may be a physical property such as sticky and nonsticky. A support vector machine, for example, predicts the class label yᵢ given the feature set \vec{f}. This means there is a mapping (function) from \vec{f} to a variable yᵢ that can take values of 0 and 1 or (more commonly) −1 and 1, yᵢ=SVM(\vec{f}). In a Gaussian process classification model, the algorithm predicts a continuous function between 0 and 1, the probability of a class label. Given n labels yᵢ with i∈[1, n], the classifier produces a probability p(yᵢ|\vec{f}), i.e. the probability of class label y, being appropriate given the feature set \vec{f} of the data (and the prior training data).

A regression model produces a continuous value v that may be outside of the range 0 to 1. A representative example is a friction coefficient. The regression algorithm is then a mapping from the feature vector to this value, v=REG(\vec{f}). Numerous regression models exist and are suitable for use herein. A simple representative example of a regression model is linear regression where v=\vec{w}·\vec{f} where \vec{w} are the parameters of the linear model.

Another representative example, of a regression model suitable for use herein, a Bayesian regression model, which does not produce the parameters \vec{w} but the distribution of the parameters p(\vec{w}|\vec{f}). A Gaussian process regression model predicts the distribution of the value itself, p(v|\vec{f}), i.e, the probability of finding value v given the feature vector \vec{f} (and the prior training data). It therefore removes the need to specify an explicit model (such as the linear model above), which is often called nonparametric regression. The underlying models still exists; it is a Gaussian process. Neural networks are also commonly used in regression (and classification) models and can be used herein.

Similar to classification, one can therefore use the scale-dependent parameters hereof to compute a feature vector and then use a regression model—either linear or Gaussian process—to compute a prediction of a continuous property given the roughness of a surface. Values of interest include, for example, friction coefficients, wear rates, adhesive forces, lifetimes, and many others. The concept behind using nonparameteric regression is to make no assumption about the underlying physical processes. The result is then some form of interpolation of the input data.

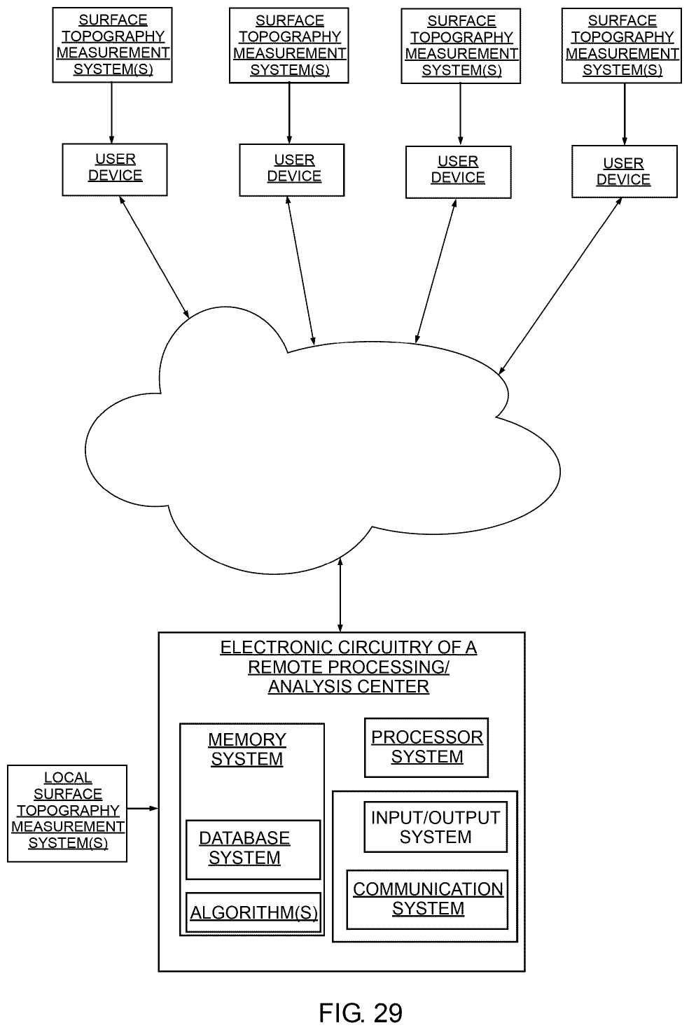

In a number of embodiments, a system hereof includes electronic circuitry including a memory system and a processor system. Such a system may, for example, be embodied in a cloud-based system including a remote process/analysis center as illustrated in the representative embodiment of FIG. 29. A database system may be stored in the memory system. The database system includes topography data associated with one or more scans of each of a plurality of surfaces. The database system may include the “raw” topography data such as surface height data from a variety of sources as illustrated in FIG. 29. For example, topography data may be taken from stores of topography data from various measurement systems such as stylus profilometry systems, optical profilometry system, cross-section or side view microscopy systems and reflectance systems.

The topography data stored in the database system may further include a statistical characterization of a distribution of one or more derivatives of surface height for at least one of the one or more scans, wherein the one or more derivatives are selected from the group consisting of a zero- and higher-order derivatives determined at each of multiple distance scales in real space using a scaling factor η which is greater than or equal to 1 and which is multiplied by the smallest possible distance scale provided by the at least one of the one or more scans.

One or more algorithms are stored in the memory system which is executable via a processor system. In a number of embodiments, the algorithm(s) include an algorithm for determined scale-dependent parameters hereof. In a number of embodiments, the algorithm(s) include at least one machine learning procedure trained using a training set of the topography data using features/feature vectors and labels of a training set of the topography data.

Moreover, surface topography data may be uploaded by users of the system and/or determined by one or more topography measurement systems local to the processing/analysis center. The data of the database system can thereby be continuously enhanced. Moreover, one or more machine learning models as described herein may be trained using additional data.

Once again, the distribution of the at least one of the first- or higher-order derivatives may, for example, be determined over the multiple distance scales via a numerical method (for example, a finite differences method) and then statistically characterized. The statistical characterization may alternatively be determined from a surface topography/roughness parameter other than an SDSP to which the SDSP is mathematically relatable. The surface roughness/topography parameter other than an SDSP may, for example, be selected from the group of an autocorrelation function characterization, a variable bandwidth characterization, or a power spectral density characterization. Moreover, feature vectors (of training set data and data input for characterization) hereof may include surface topography/roughness parameters other than SDSP (for example, power-spectral density data, height-difference autocorrelation function data and variable bandwidth characterization data). The stored topography data may, for example, be stored as combination of measurements across scales, including SDSP data, power-spectral density data, height-difference autocorrelation function data and variable bandwidth characterization data.

The algorithm stored in the memory system enables characterization of data from a surface topography measurement system input by a user of the system (for example, via a cloud-connected device such as a computer) using the one or more machine learning models of the algorithm via creation of feature vectors as described herein from the input data. Such characterization may, for example, include identifying similar surfaces in the database system (for example, as measured by other researchers/scientists/engineers). The devices, systems, and methods hereof thereby facilitate identifying and comparing research that was conducted on similar samples but carried out independently.

Further, via analysis of, for example, combinations of multiple topography measurements, the devices, systems, and methods hereof enable improved understanding of required specifications for surfaces and improved detection of out-of-spec surfaces (even from bandwidth-limited measurements obtained with a single measurement system). Moreover, data input from a user of measurements of the surface topography of a manufactured component may be used to predict the surface characterization/properties (for example, friction, adhesion) of that surface/component, to more fully understand how the component will behave in service. Additionally, by computing surface characteristics/properties based on computer-generated candidate topographies, the devices, systems, and methods hereof enable a product designer to rationally determine an optimal surface topography. Using the machine-learning model(s) of the devices, systems and methods hereof, users may input data/measurements of surface topography that are classified different ways (for example, premature failures, sufficient lifetime, etc.) and identify characteristics that correlate to component failure, lifetime, etc.

The project leading to this application has received funding from the European Research Council (ERC) under the European Union's Horizon 2020 research and innovation program (grant agreement No 757343).

The foregoing description and accompanying drawings set forth a number of representative embodiments at the present time. Various modifications, additions and alternative designs will, of course, become apparent to those skilled in the art in light of the foregoing teachings without departing from the scope hereof, which is indicated by the following claims rather than by the foregoing description. All changes and variations that fall within the meaning and range of equivalency of the claims are to be embraced within their scope.

What is claimed is:

1. A method of characterizing a surface topography, comprising: determining scale-dependent parameters, each of scale dependent parameter representing a statistical characterization of a distribution of at least one of a first-order or higher-order derivative of surface height or h determined from one or more measurements of the surface at each of multiple distance scales, wherein for at least one of the one or more measurements, the first-order or higher-order derivative of surface height is determined at the multiple distance scales in real space defined via a scaling factor η which is greater than or equal to 1 and which is multiplied by a smallest possible distance scale or resolution provided by the at least one of the one or more measurement.

2. The method of claim 1 comprising statistically characterizing the distribution of each of a plurality of derivatives of surface height of different order at the multiple distance scales in characterizing the surface topography.

3. The method of claim 1 wherein at least one of the scale-dependent parameters is determined (i) by statistically characterizing the distribution of the at least one of the first-order or higher-order derivatives determined from the one or more measurements of the surface over the multiple distance scales via a numerical method, or (ii) in a case of a second cumulant or a second moment, from a surface topography parameter which is not determined from a statistical characterization of the distribution of the first-order or higher-order derivatives of surface height determined via a numerical method, by application of a determined mathematical relationship to the surface topography parameter to convert the surface topography parameter to the scale-dependent parameter.

4. The method of claim 3 wherein the surface topography parameter is selected from the group of an autocorrelation function characterization, a variable bandwidth method characterization, or a power spectral density characterization.

5. The method of claim 3 wherein the numerical method is a finite difference method, a finite-elements method, a Fourier interpolation or another interpolation method using compact or spectral basis sets.

6. The method of claim 3 wherein the at least one of the first-order or higher-order derivatives are determined over multiple distance scales for lines of the one or more measurements of the surface or for areas of the one or more measurements of the surface.

7. The method of claim 6 wherein the distribution of the at least one of the first-order or higher-order derivatives is determined over the multiple distance scales for lines of the one or more measurements of the surface and averaged over multiple lines of the one or more measurements of the surface.

8. The method of claim 7 wherein derivatives for lines of the one or more measurements for points xₖ on the lines is provided by the formula:
$$\\ \frac{D \text{?}}{D \text{?} x \text{?}} h ( x ) ≡ \frac{1}{( η Δ x ) \text{?}} \text{?} c \text{?} h ( x \text{?} ) .$$
$$\\ \text{?} \text{indicates text missing or illegible when filed}$$
wherein α is the order, Δx is the smallest possible scale, and cₗ^{(a)} set forth a stencil of the derivative, and wherein the derivative is measured at a distance scale [symbol] =αηΔx.

9. The method of claim 8 wherein the stencils for the α=1, 2 and 3 are
c₀⁽¹⁾=−1,c₁⁽¹⁾=1,
c₀⁽²⁾=−2,cₖ₁⁽²⁾=1 and
c₀⁽³⁾=3,c₁⁽³⁾=−3,c₋₁⁽³⁾=−1,c₂⁽³⁾=1,
wherein all other cₗ^{(a)} are zero.

10. The method of claim 6 wherein the first-order or higher-order derivatives are determined for areas of the one or more measurements of the surface and the first-order or higher-order derivatives are provided by the formula:
$$\\ \frac{{D}_{( η )}^{α + β}}{{D}_{( η )} {x}^{α} {D}_{( η )} {y}^{β}} h ( x , y ) ≡ \frac{1}{{( η Δ x )}^{α} {( η Δ y )}^{β}} {\sum }_{l = - ∞}^{∞} {\sum }_{m = - ∞}^{∞} {c}_{lm}^{( α , β )} h ( x + η l Δ x , y + η m Δ y )$$
wherein α and β are orders of derivatives in the x and y directions, respectively, and cₗₘ^{(α, β)} set forth a stencil.

11. The method of claim 2 wherein the statistical characterization of the distribution is determined from a second or higher cumulant thereof or a second or higher moment thereof.

12. The method of claim 11 wherein the statistical characterization of the distribution is selected from the group consisting of variance, skewness, and kurtosis.

13. The method of claim 11 wherein the distribution is provided by the formula:
$$\\ P \text{?} ( χ : η ) = 〈 δ ( χ - \frac{D \text{?}}{D \text{?} x \text{?}} h ( x ) ) 〉 ,$$
$$\\ \text{?} \text{indicates text missing or illegible when filed}$$
wherein δ is the Dirac δ function, and χ is the value of the derivative of order α.

14. The method of claim 13 wherein the δ function is broadened into individual bins and the number of occurrences of a certain derivative value is counted.

15. The method of claim 2 wherein a tip-radius effect for a measurement methodology used for the one or more measurements is determined as a function of a minimum value of a second-order derivative at a specific scale [symbol] .

16. The method of claim 15 wherein a critical scale [symbol] ₜᵢₚ is determined and data on scales below [symbol] ₜᵢₚ are excluded to minimize tip radius effects.

17. The method of claim 16 wherein [symbol] ₜᵢₚ is estimated numerically using the formula:
h″ₘᵢₙ( [symbol] ₜᵢₚ)=c/Rₜᵢₚ
wherein h″ₘᵢₙ( [symbol] ₜᵢₚ) is minimum value of the second-order derivative at the scale ( [symbol] ₜᵢₚ) and Rₜᵢₚ is a tip radius provided by the formula:
$$\\ h \text{?} ( ℓ ) = - \text{?} [ \frac{D \text{?}}{D \text{?} x \text{?}} h ( x \text{?} ) ] .$$
$$\\ \text{?} \text{indicates text missing or illegible when filed}$$
and c is an empirically determined parameter.

18. The method of claim 2 wherein more than one measurement is used in defining the scale-dependent parameters, wherein the more than one measurement are created via different measurement methodologies and have different smallest possible distance scales or resolutions.

19. The method of claim 18 wherein the different measurement methodologies are selected from the group consisting of stylus profilometry methodologies, optical profilometry methodologies, cross-section or side-view microscopy methodologies and reflectance methodologies.

20. The method of claim 18 wherein data from the one or more measurement are combined over the multiple distance scales in determining the scale-dependent parameters.

21. The method of claim 2 wherein at least one of the one or more derivatives of surface height h is a third- or higher-order derivative.

22. The method of claim 2 wherein the statistical characterization of the distribution is determined from a third or higher cumulant thereof or from a third or higher moment thereof.

23. The method of claim 2 further comprising determining a feature vector from the one or more measurements of the surface, wherein a plurality of features of the feature vector are determined from scale dependent parameters, and based upon the feature vector, determining at least one characteristic of the subject surface.

24. A system for characterizing a surface topography, comprising:
a processor system, and
a memory system in communicative connection with the processor system, the memory system comprising an algorithm to determine scale-dependent parameters each of which is a statistical characterization of a distribution of at least one of a first-order or higher-order derivative of surface height or h determined from one or more measurements of the surface at each of multiple distance scales, wherein for at least one of the one or more measurements, the first-order or higher-order derivative of surface height is determined at the multiple distance scales in real space using a scaling factor η which is greater than or equal to 1 and which is multiplied by a smallest possible distance scale or resolution provided by the at least one of the one or more measurements.

25. The system of claim 24 wherein the algorithm statistically characterizes the distribution of each of a plurality of derivatives of surface height of different order at the multiple distance scales.

26. The system of claim 24 wherein the statistical characterization of the distribution is determined from a third or higher cumulant thereof or is a third or higher moment thereof.

27. The system of claim 24 further comprising a measurement system for measuring surface height over an area of a surface in communicative connection with the processor system.

28. A method of characterizing a surface topology of a subject surface, comprising:
determining a feature vector from one or more measurements of the subject surface, a plurality of features of the feature vector being determined from a statistical characterization of a distribution of one or more derivatives of surface height or h, wherein the one or more derivatives are selected from the group consisting of a zero- and higher-order derivative determined from at least one of one or more measurements of the subject surface at each of multiple distance scales, wherein for the at least one of the one or more measurements, the one or more derivatives of surface height are determined at the multiple distance scales in real space using a scaling factor η which is greater than or equal to 1 and which is multiplied by the smallest possible distance scale provided by the at least one of the one or more measurements,
determining via an algorithm stored in a memory system and executable via a processor system, and based upon the feature vector, at least one characteristic of the subject surface; and
providing an output indicating the at least one characteristic.
